(19) United States
(12) Patent Application Publication
(10) Pub. No.: US 2012/0308982 A1
(43) Pub. Date: Dec. 6, 2012

(54) SYSTEM AND METHOD FOR VIRTUAL SOCIAL LAB

(75) Inventors: Phillip Atiba GOFF, Los Angeles, CA (US); Kimberly Barsamian KAHN, Portland, OR (US)

(73) Assignee: JUSTICE EDUCATION SOLUTIONS, LLC, Los Angeles, CA (US)

(21) Appl. No.: 13/486,589

(22) Filed: Jun. 1, 2012

Related U.S. Application Data
(60) Provisional application No. 61/493,236, filed on Jun. 3, 2011.

(51) Int. Cl. G09B 7/00

(52) U.S. Cl. 434/362

(57) ABSTRACT

A method implemented in a computer infrastructure having computer executable code tangibly embodied on a computer readable medium. The method includes configuring a VSL scenario using a processor of a computing device, and running the VSL scenario for a test subject. Additionally, the method includes receiving test subject input based on the VSL scenario and storing the test subject input.

### CROSS REFERENCE TO RELATED APPLICATION

The present application claims priority to U.S. Provisional Application No. 61/493,236 filed on Jun. 3, 2011, the disclosure of which is expressly incorporated by reference herein in its entirety.

### FIELD OF THE INVENTION

The present invention generally relates to computer-based virtual universes, and more specifically, to methods and systems for a virtual social lab within a virtual universe environment.

### BACKGROUND OF THE INVENTION

Virtual universes (VUs) are rapidly becoming a popular part of today's culture. A VU is a computer-based simulated environment. Many VUs are represented using 3-D graphics and landscapes, and are populated by many thousands of users, known as “residents”. Often, the VU resembles the real world such as in terms of physics, houses, and landscapes.

VUs are also known as metaverses and “3D Internet.” Some example VUs include: SECOND LIFE®, ENTROPIA UNIVERSE®, THE SIMS ONLINE® and THERE^{SM}—as well as massively multiplayer online games such as EVERQUEST®, ULTIMA ONLINE®, LINEAGE® and WORLD OF WARCRAFT®. (SECOND LIFE is a registered trademark of Linden Research, Inc. in the United States and/or other countries. ENTROPIA UNIVERSE is a registered trademark of MindArk PE AB in the United States, other countries, or both. THE SIMS ONLINE and ULTIMA ONLINE are registered trademarks of Electronic Arts, Inc. in the United States, other countries, or both. THERE is a trademark of Makena Technologies, Inc. in the United States, other countries, or both. EVERQUEST is a registered trademark of Sony Corporation of America, Inc. in the United States, other countries, or both. LINEAGE is a registered trademark of NCsoft Corporation in the United States, other countries, or both. WORLD OF WARCRAFT is a registered trademark of Blizzard Entertainment, Inc. in the United States, other countries, or both.)

A VU is intended for its residents to traverse, inhabit, and interact through the use of avatars. In operation, user(s) control the avatar(s). An avatar is a graphical representation of the user, often taking the form of a cartoon-like human or other figure. The user's account, upon which the user can build an avatar, is tied to the inventory of assets the User owns. A region is a virtual area of land within the VU, typically residing on a server. Assets, avatar(s), the environment, and everything else visually represented in the VU each comprise universally unique identifiers (UUIDs) (tied to geometric data distributed to user(s) as textual coordinates), textures (distributed to user(s) as graphics files), and effects data (rendered by the user's client according to the user's preference(s) and user's device capabilities).

The data representation of an object or item in the VU is stored as information, e.g., as data or metadata. The object may be created by an object creator, e.g., a VU manager, a user, etc. In some virtual universes, larger objects are constructed of smaller objects, termed “prims” for primitive objects. These “prims” usually include boxes, prisms, spheres, cylinders, tori, tubes and/or rings. The “prims” may be rearranged, resized, rotated, twisted, tapered, dimpled and linked to create larger composite objects. The creator of such an object may then map a texture or multiple textures to the object. Texture mapping is a method of adding detail, surface texture, or color to a computer-generated graphic or 3D model. When the object is to be rendered, this information is transmitted from the VU server to the client.

### SUMMARY OF EMBODIMENTS OF THE INVENTION

On-line VUs or environments present a tremendous new outlet for both structured and unstructured virtual collaboration, gaming and exploration, as well as real-life simulations in virtual spaces. These activities, along with yet to be disclosed new dimensions, in turn, provide a wide open arena for creating and conducting social experiments.

In an aspect of the invention, a method implemented in a computer infrastructure having computer executable code tangibly embodied on a computer readable medium, comprises configuring a VSL scenario using a processor of a computing device, and running the VSL scenario for a test subject. Additionally, the method comprises receiving test subject input based on the VSL scenario; and storing the test subject input.

In embodiments, the running the VSL scenario for the at least one test subject is performed without the at least one test subject being physically present in a controlled laboratory setting.

In embodiments, the running the VSL scenario comprises randomly assigning two or more test subjects to the VSL scenario, at least two of the two or more test subjects located in different respective locations, and the receiving the test subject input comprises receiving the test subject input from the different respective locations.

In further embodiments, the running the VSL scenario for the at least one test subject comprises utilizing a social network website.

In additional embodiments, the VSL scenario comprises an animated scene depicting one or more interactions between at least two characters in an environment.

In yet further embodiments, the environment comprises at least one of a nightclub, a restaurant, a police station, a government building, a school, an office building, an airport security line, a classroom, and an emergency room.

In embodiments, the at least two characters comprise a decider character with authority to grant or deny access within the environment, and one or more characters seeking the access within the environment.

In further embodiments, the receiving the test subject input based on the VSL scenario comprises receiving at least one of an indication of a test subject's comfort with the interaction, an indication of the test subject's anticipation of what will happen next in the interaction, and a decision to grant or deny one of the at least two characters access within the environment.

In additional embodiments, the receiving the test subject input based on the VSL scenario comprises receiving at least one of: a real-time indication, a survey response, biometric information, and a reaction time indication.

In yet further embodiments, the configuring the VSL scenario comprises configuring one or more parameters selected from: a number of interactions, a user input mode, an environment, a reject/accept ratio, and a percentage of occurrence of one or more character variables.

In embodiments, the one or more character variables comprise at least one of: a gender, a race, a weight, a height, clothing, a degree of stereotypicality of skin tone, masculinity-femininity, an emotion on a character's face, an emotional expression indicated on (or by) a character's body, a gait, a voice, a disability, a usage of jewelry, a hairstyle, a personalization, an eye gaze, and a custom variable.

In further embodiments, the configuring the VSL scenario comprises selecting a test subject perspective from one of: a 3^{rd} person perspective, wherein the test subject observes and reacts to other characters interacting in the VSL scenario; a 1^{st} person perspective, wherein the test subject interacts in the VSL scenario; and a plurality of characters.

In additional embodiments, the configuring the VSL scenario comprises configuring one or more subgroups of characters.

In yet further embodiments, the configuring the one or more subgroups of characters comprises at least one of an automatic generation of one or more character variables, and a custom generation of the one or more character variables.

In embodiments, the configuring the VSL scenario comprises receiving a selection of one or more variables for a decider character, and receiving a selection of one or more variables for one or more characters seeking admittance within an environment.

In further embodiments, the configuring the VSL scenario comprises configuring the one or more interactions between the at least two characters.

In additional embodiments, the configuring the VSL scenario comprises configuring at least one of a timing, a content, and a format of one or more scenario questions.

In yet further embodiments, the test subject input provides an objective measure of at least one of bias perception, individual attitudes, and other socially-observable phenomenon.

Additional aspects of the present disclosure are directed to a system for conducting a study in a virtual social lab (VSL). The system comprises a scenario creation tool operable to receive one or more parameters for configuring a VSL scenario, and to create the VSL scenario, a scenario running tool operable to run the VSL scenario for at least one test subject, and to receive test subject input based on the VSL scenario, and a data storage tool operable to store the test subject input.

Additional aspects of the present disclosure are directed to a computer program product for conducting a study in a virtual social lab (VSL), the computer program product comprising a computer usable non-transitory storage medium having readable program code embodied in the storage medium. The computer program product includes at least one component operable to configure a virtual social lab (VSL) scenario, run the VSL scenario for at least one test subject, receive test subject input based on the VSL scenario, and store the test subject input.

Additional aspects of the present disclosure are directed to a method for configuring a virtual social lab (VSL) scenario implemented in a computer infrastructure having computer executable code tangibly embodied on a computer readable medium, wherein the scenario includes an animated scene depicting an interaction between at least two characters in an environment. The method comprises configuring one or more scenario parameters using a processor of a computing device, the one or more parameters selected from: a number of interactions, a user input mode, an environment, a reject/accept ratio, and a percentage of occurrence of one or more character variables. The one or more character variables comprise at least one of: a gender, a race, a weight, a height, clothing, a degree of stereotypicality of skin tone, masculinity-femininity, an emotion on a character's face, an emotional expression indicated on (or by) a character's body, a gait, a voice, a disability, a usage of jewelry, a hairstyle, a personalization, an eye gaze, and a custom variable. The method further comprises selecting a test subject perspective from one of: a 3^{rd} person perspective, wherein the test subject observes other characters interacting in the VSL scenario; a 1^{st} person perspective, wherein the test subject interacts in the VSL scenario; and a plurality of characters, and configuring one or more interactions between the at least two characters.

### BRIEF DESCRIPTION OF THE DRAWINGS

The present invention is described in the detailed description which follows, in reference to the noted plurality of drawings by way of non-limiting examples of exemplary embodiments of the present invention.

FIG. 1 shows an illustrative environment for implementing the steps in accordance with the invention;

FIGS. 2-5 are exemplary flow diagrams for implementing aspects of the present invention;

FIG. 6 illustrates an exemplary VSL license key structure in accordance with aspects of the invention;

FIG. 7 illustrates an exemplary basic information page in accordance with aspects of the invention;

FIG. 8 illustrates an exemplary environment selection page in accordance with aspects of the invention;

FIG. 9 illustrates an exemplary environment preview page in accordance with aspects of the invention;

FIG. 10 illustrates an exemplary subgroup summary page in accordance with aspects of the invention;

FIG. 11 illustrates an exemplary create avatars subgroup page in accordance with aspects of the invention;

FIG. 12 illustrates an exemplary auto create avatars subgroup page with an avatar variables selection interface in accordance with aspects of the invention;

FIG. 13 illustrates an exemplary auto create avatars subgroup page with an avatar variables setting interface in accordance with aspects of the invention;

FIG. 14 illustrates an exemplary custom create avatars subgroup page for a custom avatar selection in accordance with aspects of the invention;

FIG. 15 illustrates an exemplary avatar selection summary page in accordance with aspects of the invention;

FIG. 16 illustrates an exemplary decider selection page in accordance with aspects of the invention;

FIG. 17 illustrates an exemplary avatar properties page in accordance with aspects of the invention;

FIG. 18 illustrates an exemplary scenario summary page in accordance with aspects of the invention;

FIG. 19 illustrates an exemplary scenario questions page in accordance with aspects of the invention;

FIG. 20 illustrates an exemplary questions summary and preview page in accordance with aspects of the invention;

FIG. 21 illustrates an exemplary scenario preview page in accordance with aspects of the invention; and

FIG. 22 illustrates an exemplary scenario environment in accordance with aspects of the invention.

### DETAILED DESCRIPTION OF EMBODIMENTS OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

The present invention generally relates to computer-based virtual universes (VUs), and more specifically, to methods and systems for a virtual social lab (VSL) in a VU environment. In embodiments, the VSL is an interactive research tool designed to assess a subject's sensitivity to issues of, for example, race, gender, and other social factors.

In embodiments, the present invention is operable to provide a virtual world in which researchers set up scenarios for subjects to observe or participate in. In embodiments, scenarios may include, for example, interactions between people of different races, ethnicities, genders and/or ages, amongst other differences. In embodiments, the present invention is operable to render characters and VU environments in photorealistic 3D. In embodiments, a VSL in a VU environment may include a VSL as a standalone VU and/or a VSL within another VU (e.g., THE SIMS ONLINE.) In embodiments, the present invention is operable to collect data about user actions in each scenario, such that a researcher may, for example, compare that data across subjects. In embodiments, the present invention may be utilized for: (1) general opinion data collection; (2) social science research; and (3) human resources contexts, amongst other fields of study.

### General Opinion Data Collection

Previously, gathering public opinions was performed by specialized researchers and marketing firms. With the emergence of online resources such as Survey Monkey, Qualtrics, Knowledge Networks, and the like, opinion research has become more democratic and the market is saturated with forms that ask for your opinions. For example, Survey Monkey has demonstrated that random Facebook data on presidential approval had a strong correlation with the Gallup presidential approval ratings (matched to the percentage point over a two-week period), demonstrating that new methods of data collection may be as accurate as older methods, while being more agile and cheaper than older methods. This information has also become increasingly valuable, as the science of market research has become more widely available to small businesses and startups.

Given the growth in everyday capacity to gather opinion information, many market researchers are looking for the fastest and most agile adaptable way to get reliable data.

### Social Science Research

Similarly, social science researchers have used opinion research methods (e.g., Survey Monkey) to collect empirical data online. Project Implicit (https://implicit.harvard.edu/implicit/), for example, has collected data from millions of individuals on their implicit attitudes about a wide range of topics and people. These online tests and surveys are a quick way to collect reliable data that can be published in peer-reviewed journals and have become increasingly popular among social scientists interested both in Internet behavior and real-world attitudes. The growing popularity of online research is aided by the fact that many students prefer participating in research online to participating in person. Since the vast majority of psychological research utilizes undergraduate participants who complete studies in exchange for course credit, this growing popularity of online research has led multiple psychology departments to restrict the number of “online” studies that may be available at any given time to ensure there are enough participants for more involved research.

These online research data, however, have been limited mostly to online behaviors or attitude assessments due to the inability to collect data on other “real-world” behaviors online. The inability of traditional online opinion research tools to immerse individuals or groups in actual situations has also limited the use of online data collection.

### Human Resource Contexts

Human resource (HR) departments have long bemoaned both the difficulty of achieving successful racial and gender integration, and the costs of failing to integrate successfully. For example, in the domain of policing alone, city and state governments routinely pay millions of dollars to resolve racial and gender litigation and consent decrees annually. As of Jul. 1 of 2009, the New Jersey State Police, for example, had reportedly spent at least $137.5 million complying with a consent decree requiring it to monitor traffic stops for racial profiling. Similarly, a Los Angeles Police Department consent decree was estimated at a cost of between $30 and $50 million annually. A recent Cincinnati consent decree cost approximately $13 million to set up and over $20 million annually to ensure compliance.

In law enforcement, as in other professions, it is difficult to identify individuals who are likely to engage in biased behavior before they are hired. Moreover, it is difficult to train individuals to be less biased and difficult to use one's ability to facilitate an equitable working environment as a metric for promotion. Consequently, organizations are often forced to make educated guesses about what might produce optimal conditions for successful diversity efforts. There is little evidence that diversity trainings reduce racial or gender bias. Moreover, employers are often legally prohibited from asking the kinds of questions that scientists know predict racial bias, in part, because there is not a way to create an objective performance task (rather than a measure of attitudes) that predicts racial bias or one's ability to identify it. Consequently, most HR specialists and so-called “diversity trainers” are unable to provide empirical evidence of the utility of their services.

In embodiments, the present invention comprises a research tool that enables social scientists and public opinion researchers to present individuals with engaging scenarios about which the researchers can ask the participants questions. By implementing the present invention, individuals can be immersed in realistic social situations within a VU. In embodiments, the present invention is operable to extract reliable data from participants on a host of dimensions, including, for example, face perception, stereotypes of individuals, judgments of implicit and explicit bias, judgments of a target's competency, and judgments about a target's level of bias, amongst other contemplated dimensions. The extracted data may be, for example, subjected to a signal detection analysis to investigate accuracy regarding discrimination. By implementing aspects of the present invention, experimental psychologists, businesses, and/or opinion researchers, for example, are able to gather data (e.g., all the data normally collected from people in conventional experiments) through an online immersive environment and system having an improved method of data collection and an improved methodological flexibility.

In embodiments, the present invention is easily configurable to be adapted to different situations, such that an individual (e.g., a researcher) may change, for example, the nature of the questions being asked in the VSL and/or the scenario presented within the VSL with relative ease. In accordance with aspects of the invention, in embodiments, researchers may create their own experiments, marketing scenarios and/or public opinion contexts. By implementing the present invention, researchers may create their own experiments using less time and human resources than more traditional data collection methods. For example, in embodiments, individual participants in a VSL experiment may be asked for information about a single item, and/or have their aggregate responses analyzed. Similarly, in embodiments, data can be collected from experiments that are made to appear like games on social networking sites such as Facebook®. By implementing the present invention, data may be collected from experiments that are made to appear like games, enabling the collection of large amounts of data in a short amount of time.

In embodiments, the VSL may store (e.g., in a memory device) collected data such that individuals may gain access to large aggregate datasets from experiments in order to, for example, perform secondary data analyses.

There are a plurality of domains in which the present invention provides for novel methods and systems of data collection, analysis, and use.

Types of data collected: There has not previously been a data collection device that allows researchers to design and collect experimental data easily online. By implementing the present invention, a data collection system and method is provided that allows researchers to design and collect experimental data more easily than traditional methods.

Agility and capacity of data collection: There has not previously been a system or program that provides the level of agility and capacity necessary to collect experimental data online. Rather than bringing people into a controlled laboratory setting to conduct experimental manipulations (e.g., regarding face perception, social interactions and/or the role of situations in producing behaviors), by implementing the present invention, researchers may conduct experiments with subjects without the subject being physically present in the controlled lab setting. For example, with the embodiments of the present invention, researchers are able to randomly assign individuals to an experimental condition and receive information from them, for example, without the individual leaving their home. By creating an adaptable template onto which researchers can upload their own stimuli and situations, the present invention also provides researchers (of all stripes) with the ability to collect data at a pace and/or from populations that were previously not accessible or not practicable.

Ease of collecting data from non-university students: For academic researchers, e.g., psychologists, by implementing the present invention, data may be collected via social network sites. Thus, by implementing the present invention, researchers may collect experimental data from populations that are not well represented by university undergraduates.

Outcomes test of one's ability to identify discrimination: As it is not legal to make employment decisions based on racial or gender attitudes, organizations have struggled to produce satisfactory mechanisms that result in trainings, hiring, and promotion strategies to ensure an equitable workplace. However, significant research literature exists demonstrating a desire among individuals that engage in discrimination to minimize the existence of discrimination. In accordance with aspects of the present invention, using the VSL to identify an individual's accuracy in gauging the amount of discrimination existing in a given VU environment (e.g., a scenario) would be a legal and an outcomes-based manner for: (1) screening individuals regarding, for example, their level of bias; and/or (2) training individuals to become more astute observers of discrimination.

A mechanism for conducting nationally representative immersive experiments: A common criticism of social psychological research is its lack of generalizability given the tendency to use university undergraduates as participants. It is also the case that using smaller numbers of participants is often valued in prestigious experimental psychology journals because demonstrating effects with smaller numbers of participants reveals the power of one's effect. By implementing the present invention, however, the VSL would allow an individual to conduct experiments with regionally or nationally representative samples, permitting both small or large datasets to be created, and exploding previously limitations on subject populations.

### Exemplary Embodiment

With an exemplary and non-limiting embodiment, the present invention is operable to display, for example, 2D or 3D animated scenes depicting an interaction between two characters in a variety of environments. In embodiments, the various environments may include, for example: a nightclub, a restaurant, a government building, a school, an office building, an airport security line, and/or an emergency room, amongst other contemplated virtual environments.

With this exemplary embodiment, the VSL utilizes two characters, wherein the first character is a “bouncer” or “guard” with the authority to grant or deny the other character (e.g., a “customer,” an “applicant,” or a “perpetrator,” amongst other contemplated characters) access into a building or venue. In accordance with aspects of the invention, each interaction has two possible outcomes: (1) the “customer” is accepted with a nod of the head (yes); or (2) the customer is rejected with a shake of the head (no).

In accordance with further aspects of the invention, the VSL provides the researchers the ability to control and configure the parameters for the scenes and/or each character.

In embodiments, there may be two types of users for the VSL; namely, a researcher and a test subject. Each of these users has different types of interactions with the VSL. For example, in embodiments, a researcher may interact with the VSL to: (1) control, configure and/or save the parameters for an experiment (e.g., one or more scenarios); (2) conduct an experiment and collect data; and/or (3) retrieve collected data from the VSL.

In embodiments, the subject may interact with the VSL, for example, in at least three different ways (depending on the settings determined by the researcher). For example, in embodiments, the subject may indicate to the VSL, e.g., on a scale, their comfort with each interaction (e.g., an interactive feeling gauge). Additionally, in embodiments, the subject may indicate to the VSL, for example, their anticipation of what may happen in a scenario (e.g., make judgments before actions occur on how likely someone is to be discriminated against). For example, in embodiments, participants may indicate their responses in the VSL by clicking a response marker on their computer (e.g., with a mouse or by pressing a button). In embodiments, the VSL may be configured to ask questions (e.g., “on a scale of 1 to 7 . . . ”), and receive participants (e.g., test subjects) responses to them. Further, in embodiments, the subject may act as bouncer, making decisions to admit or deny other characters in the VSL, for example, entry to a location.

In embodiments, the present invention may receive subjects inputs utilizing, for example, real-time indicators, survey responses, biometric interfaces (e.g., galvanic skin response, fMRI scans for brain activation, etc.), and reaction time indicators. Additional embodiments may include receiving speech information and non-verbal inputs through, for example, video recordings.

In embodiments, implementing aspects of the present invention may include three stages: (1) setup of a particular experiment (e.g., one or more scenarios); (2) action (i.e., running the scenario(s)); and (3) data collection.

### Setup of a Scenario

In accordance with aspects of the invention, a researcher may configure and save parameters for the VSL, for example, based on areas of research the researcher wants to study. In embodiments, the parameters may include, for example:

1. the number of interactions (e.g., the number of nightclub-goers a bouncer encounters in a particular scenario);

2. the user input mode (e.g., record comfort, anticipate action, or act as bouncer);

3. the setting(s) (or environment) for the interactions. In embodiments, options for the settings may include: (a) a nightclub exterior; (b) a police station interior; (c) a courtroom (or other government building) interior; (d) a hospital emergency room lobby interior; (e) a bank interior; (f) an airport security line; and/or (g) a school classroom, amongst other contemplated settings;

4. the percentage of reject versus accept outcomes (e.g., reject/accept ratio) per character variables (unless user is acting as bouncer); For example, when a researcher is looking at racial bias, they may want to test whether or not someone is accurate in guessing how many individuals from each racial group are rejected by the bouncer. The “percentage of reject v. accept” is the percentage of, for example, Black customers admitted to a club (as compared to, for example, the percentage of White customers admitted to the club).

5. the percentage of occurrence of each character variable within the scenario, for example, including: (a) gender of characters; (b) race of characters (e.g., White, Black, Asian, Latino, Middle Eastern, Native American, etc.). For example, each race may be set to occur from 0% to 100% of the time, with the total to equal 100%; (c) weight of characters (for example, anywhere within a full range of weight, from thin (or low weight) through average weight to obese); (d) height of characters (for example, anywhere within a full range of heights); (e) clothing of characters (e.g., various degrees of casual, sports, and formal wear, as well as clothing that is stereotypical to various racial and/or socioeconomic groups). In embodiments, clothing variables may also include, for example, prison attire (e.g., orange jumpsuits) and indigenous clothing, and clothing associated with particular jobs (e.g., police officers, firemen, etc.); (f) a degree of stereotypicality of skin tone (i.e., the degree to which each character appears stereotypical of their race); (g) masculinity-femininity of characters (e.g., non-masculine male, average male, hyper-masculine male, non-feminine female, average female, hyper-feminine female.) In embodiments, the VSL may be configured to represent the masculinity-femininity of the characters using the face and/or the body type of the characters; (h) emotions on a character's face (e.g., a full range of emotions, including happy, neutral, sad, angry, and confused, amongst other contemplated indications of emotions); (i) emotional expressions indicated on (or by) the character's body (e.g., jumping for joy, angry pumping fists, dejected, and cowering, amongst other contemplated bodily expressions of emotions); (j) gait (e.g., speed, racial and/or gender typicality of gait); (k) voice of characters (e.g., an ability to alter timber, pitch, and/or other contemplated vocal characteristics), including the use of, for example: (i) preprogrammed vocal settings; (ii) text bubbles; (iii) text and preprogrammed vocal settings; and/or (iv) an ability to upload custom vocals for all characters; (l) personalized characters (e.g., an avatar); for example, an ability to upload pictures or photographs for characters. For example, a user may upload pictures of faces, full body and/or clothing with the ability to create a personalized avatar. In embodiments, the avatar may be saved and used in future iterations; (m) disabled characters (for example, being handicapped, physically disabled, having a physical deformity (e.g., dwarfism), on crutches, and/or having mental disabilities, amongst other contemplated disabilities); (n) use of jewelry; (o) hairstyle of characters; and/or (p) eye gaze of bouncer and customer (e.g., direct, indirect, shifty, amongst other contemplated eye gazes).

### Running the Scenario

In accordance with aspects of the invention, once the researcher has set up the scenario parameters for the study (or experiment) within the VSL (i.e., the scenario(s)), a test subject (or subjects) is subjected to the scenario(s). In embodiments, depending on the settings selected by the researcher, the subject will view one or more scenarios from one of several perspectives: (1) as a 3^{rd} person, wherein the subject views other characters interacting; (2) as a 1^{st} person, wherein the subject takes the perspective of, for example, the bouncer or the customer; and (3) as a plurality of characters (e.g., 2-3), such that multiple characters have group interactions at one time. With the 1^{st} person perspective, the subject is the one being rejected or doing the rejecting. Additionally, in embodiments, the present invention may be configured to, for example, conduct scenarios for multiple users at the same time.

Depending on researcher settings, subjects may: (1) observe interactions in the VSL, and record on a scale their comfort with each interaction (e.g., an interactive feeling gauge) and/or anticipate what will happen in a scenario (e.g., make judgments before actions occur on how likely someone is to be discriminated against); and/or (2) actively participate in interactions, for example, as a bouncer making decisions to admit or deny entry to characters, and/or as customer, being granted or denied access.

### Capturing and Reporting Data

In accordance with aspects of the invention, the VSL is operable to capture and report data points for use by the researchers. In embodiments, the format of these reports may be XML, HTML, plain text, PDF, and/or some combination of these different formats.

In embodiments, the VSL is operable to capture and report data points, including, for example: (1) a number of interactions; (2) the setting of the scenario; (3) the characters used (including specific characteristics of each character); (4) parameter settings; (5) the order of customers (for example, the order of club-goers (or customers) the bouncer sees, e.g. Black first, then three Latino, then White, then another Black, etc.); (6) accept/reject statistics; and (7) test subject data (for example, demographics of the actual test participant, as well as psychometrics on that participant (e.g., self-esteem and/or prejudice, etc.), amongst other contemplated data points.

In accordance with additional aspects of the invention, in embodiments, the VSL is operable to provide additional data collection capabilities. For example, additional data collection capabilities may include: (1) linking the VSL to existing data collection programs and psychological research tools including, for example: eprime, superlab, medialab, matlab, directRT, eyetracking, amongst other existing data collection programs and psychological research tools; (2) linking the VSL to physiological measures (e.g., blood pressure monitors and/or galvanic skin response, amongst other contemplated physiological measures); (3) adding joystick capabilities to current functionalities; and (4) ability to link to a functional magnetic resonance imaging (FMRI) scanner, such that a user can interact with the VSL while in an FMRI scanner to assess the brain of the user while he or she is completing tasks.

In embodiments, collected data may be hosted and stored on a server. In embodiments, an original research team may have access to any of their collected data for meta analysis. Additionally, in embodiments, the original research team may have a right to publish after a predetermined period of time (e.g., 18 months). In further embodiments, the present invention may be configured to charge for access to data after a predetermined period of time (e.g., 18 months).

### System Environment

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following:

an electrical connection having one or more wires,

a portable computer diskette,

a hard disk,

a random access memory (RAM),

a read-only memory (ROM),

an erasable programmable read-only memory (EPROM or Flash memory),

an optical fiber,

a portable compact disc read-only memory (CDROM),

an optical storage device,

a transmission media such as those supporting the Internet or an intranet, or

a magnetic storage device.

In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network. This may include, for example, a local area network (LAN) or a wide area network (WAN), or the connection may be made to an external computer (for example, through the Internet using an Internet Service Provider).

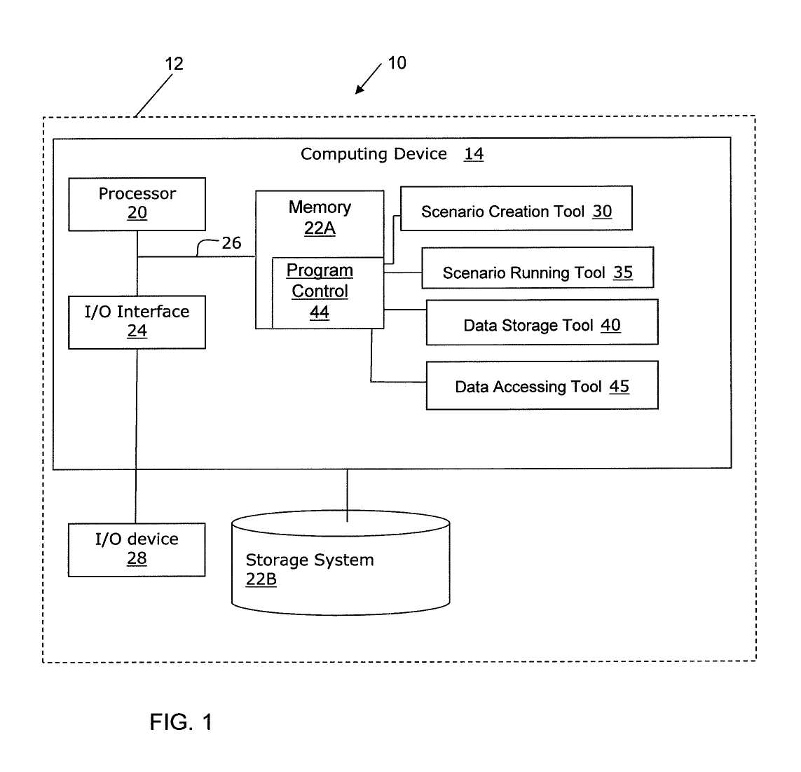

FIG. 1 shows an illustrative environment 10 for managing the processes in accordance with the invention. To this extent, the environment 10 includes a computer infrastructure 12 that can perform the processes described herein using a computing device 14. The computing device 14 includes a scenario creation/editing tool 30, a scenario running tool 35, an data storage tool 40, and a data access tool 45. These tools are operable to facilitate creation and/or editing scenarios and/or characters, running of the scenarios, the collection of data from the scenarios and the accessing the collected data, e.g., the processes described herein.

The computing device 14 includes a processor 20, a memory 22A, an input/output (I/O) interface 24, and a bus 26. The memory 22A can include local memory employed during actual execution of program code, bulk storage, and cache memories which provide temporary storage of at least some program code in order to reduce the number of times code must be retrieved from bulk storage during execution.

Further, the computing device 14 is in communication with an external I/O device/resource 28. The external I/O device/resource 28 may be keyboards, displays, pointing devices, etc. The I/O device 28 can interact with the computing device 14 or any device that enables the computing device 14 to communicate with one or more other computing devices using any type of communications link. Additionally, in embodiments, the computing device 14 includes a storage system 22B.

The processor 20 executes computer program code (e.g., program control 44), which is stored in memory 22A and/or storage system 22B. Program control 44 executes processes and is stored on media, as discussed herein. While executing computer program code, the processor 20 can read and/or write data to/from memory 22A, storage system 22B, and/or I/O interface 24. The bus 26 provides a communications link between each of the components in the computing device 14.

The computing device 14 can comprise any general purpose computing article of manufacture capable of executing computer program code installed thereon (e.g., a personal computer, server, handheld device, etc.). However, it is understood that the computing device 14 is only representative of various possible equivalent computing devices that may perform the processes described herein. To this extent, in embodiments, the functionality provided by the computing device 14 can be implemented by a computing article of manufacture that includes any combination of general and/or specific purpose hardware and/or computer program code. In each embodiment, the program code and hardware can be created using standard programming and engineering techniques, respectively.

Similarly, the computer infrastructure 12 is only illustrative of various types of computer infrastructures for implementing the invention. For example, in embodiments, the computer infrastructure 12 comprises two or more computing devices (e.g., a server cluster) that communicate over any type of communications link, such as a network, a shared memory, or the like, to perform the processes described herein. Further, while performing the processes described herein, one or more computing devices in the computer infrastructure 12 can communicate with one or more other computing devices external to computer infrastructure 12 using any type of communications link. The communications link can comprise any combination of wired and/or wireless links; any combination of one or more types of networks (e.g., the Internet, a wide area network, a local area network, a virtual private network, etc.); and/or utilize any combination of transmission techniques and protocols.

In embodiments, the computer infrastructure 12 may communicate with one or more other computer infrastructures (not shown), which are presenting the VSL to one or more test subjects. However, the invention contemplates that the computer infrastructure 12 may operate the scenario creation/editing tool 30, the scenario running tool 35, the data storage tool 40, and the data access tool 45 and presenting the VSL to one or more test subjects.

In embodiments, a service provider could offer to perform the processes described herein. In this case, the service provider can create, maintain, deploy, support, etc., a computer infrastructure that performs the process steps of the invention for one or more customers. In return, the service provider can receive payment from the customer(s) under a subscription and/or fee agreement and/or the service provider can receive payment from the sale of advertising content to one or more third parties.

In embodiments, the VSL may be a web-based application for Mac, Windows PC and/or Facebook (or other social media applications). In embodiments, the PC and/or Mac applications may be the primary access point used by researchers. Additionally, in embodiments, the Facebook applications may provide a free conduit to a large audience of users to collect a high volume of data from a less controlled subject group. In embodiments, the VSL is operable to provide a hyperlink in Facebook that will take someone from Facebook to the VSL.

### Flow Diagrams

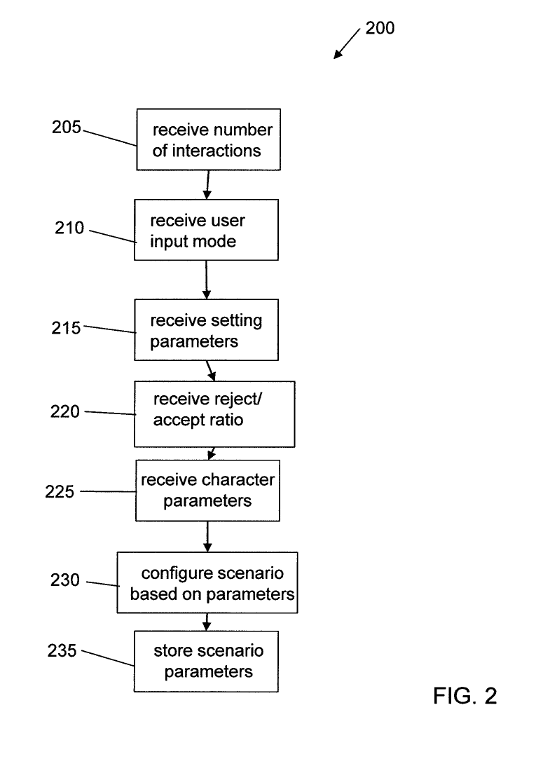

FIGS. 2-5 show exemplary flows for performing aspects of the present invention. The steps of FIGS. 2-5 may be implemented in the environment of FIG. 1, for example. The flow diagrams may equally represent high-level block diagrams of the invention. The flowcharts and/or block diagrams in FIGS. 2-5 illustrate the architecture, functionality, and operation of possible implementations of systems, methods and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. Each block of each flowchart, and combinations of the flowchart illustrations can be implemented by special purpose hardware-based systems that perform the specified functions or acts, or combinations of special purpose hardware and computer instructions and/or software, as described above. Moreover, the steps of the flow diagrams may be implemented and executed from either a server, in a client server relationship, or they may run on a user workstation with operative information conveyed to the user workstation. In an embodiment, the software elements include firmware, resident software, microcode, etc.

Furthermore, the invention can take the form of a computer program product accessible from a computer-usable or computer-readable medium providing program code for use by or in connection with a computer or any instruction execution system. The software and/or computer program product can be implemented in the environment of FIG. 1. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable storage medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disc-read/write (CD-R/W) and DVD.

FIG. 2 shows an exemplary flow 200 for configuring an experiment (or study) in accordance with aspects of the present invention. At step 205, the scenario creation/editing tool receives a number of interactions for the experiment (e.g., from a researcher). At step 210, the scenario creation/editing tool receives a user input mode (e.g., record comfort, anticipate action and/or act as bouncer). At step 215, the scenario creation/editing tool receives the setting(s) for the experiment (e.g., nightclub, police station, courtroom, etc.). At optional step 220, the scenario creation/editing tool receives the rejection/accept ratio. At step 225, the scenario creation/editing tool receives the character variable percentages. At step 230, the scenario creation/editing tool configures the one or more scenarios of the experiment (or study) based on the received scenario parameters. At step 235, the scenario creation/editing tool saves the created scenario(s) in a storage system (e.g., storage system 22B of FIG. 1)

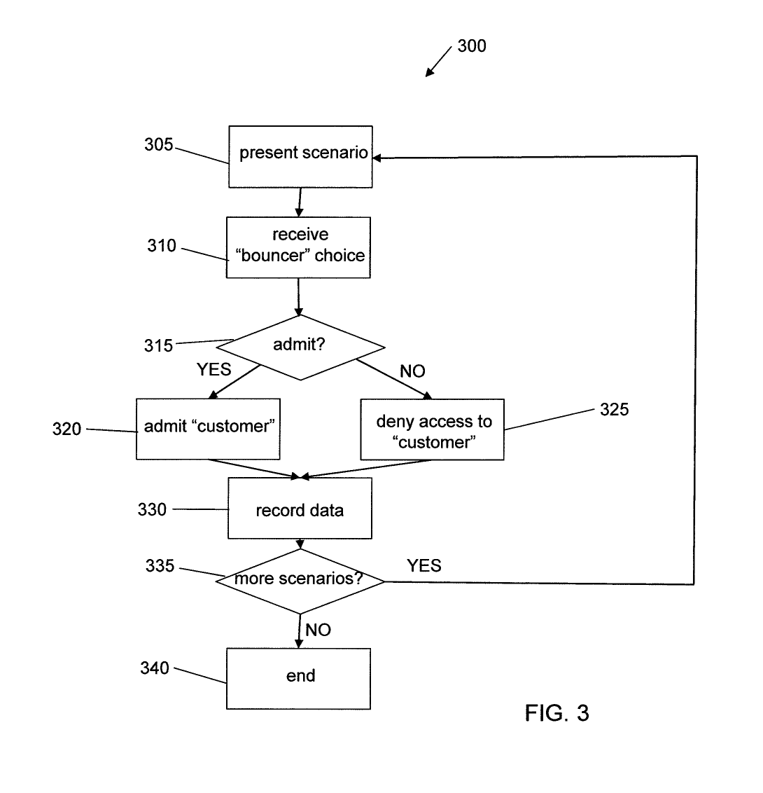

FIG. 3 shows an exemplary flow 300 for conducting (or running) an experiment (or study) in accordance with aspects of the present invention. At step 305, the scenario running tool presents a scenario to a test subject. At step 310, the scenario running tool receives a “bouncer” choice (e.g., admit or deny access to a customer). At step 315, the scenario running tool determines whether to admit the customer based on the received choice. If, at step 315, the scenario running tool makes a determination to admit the customer based on the received choice, at step 320, the scenario running tool admits the customer. If, at step 315, the scenario running tool makes a determination to deny access to the customer based on the received choice, at step 325, the scenario running tool denies access to the customer. At step 330, the data collection tool saves (e.g., in storage system 22B of FIG. 1) the received data (e.g., the bouncer's admit/deny choice and/or the customer's reaction to the bouncer's decision). At step 335, the scenario running tool determines whether the experiment (or study) includes additional scenarios. If, at step 335, the scenario running tool determines that the experiment (or study) includes additional scenarios, the process continues at step 305. If, at step 335, the scenario running tool determines that the experiment (or study) does not include additional scenarios, the process ends at step 340.

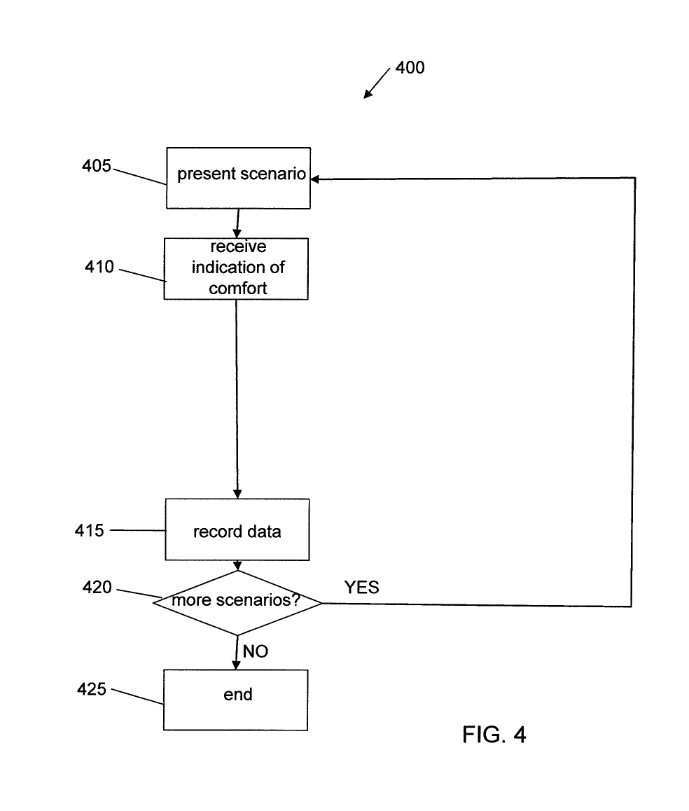

FIG. 4 shows an exemplary flow 400 for conducting (or running) an experiment (or study) in accordance with aspects of the present invention. At step 405, the scenario running tool presents a scenario to a test subject. At step 410, the scenario running tool receives a test subject's indication of comfort. At step, 415 the data collection tool saves (e.g., in storage system 22B of FIG. 1) the received data (e.g., the test subject's indication of comfort). At step 420, the scenario running tool determines whether the experiment (or study) includes additional scenarios. If, at step 420, the scenario running tool determines that the experiment (or study) includes additional scenarios, the process continues at step 405. If, at step 420, the scenario running tool determines that the experiment (or study) does not include additional scenarios, the process ends at step 425.

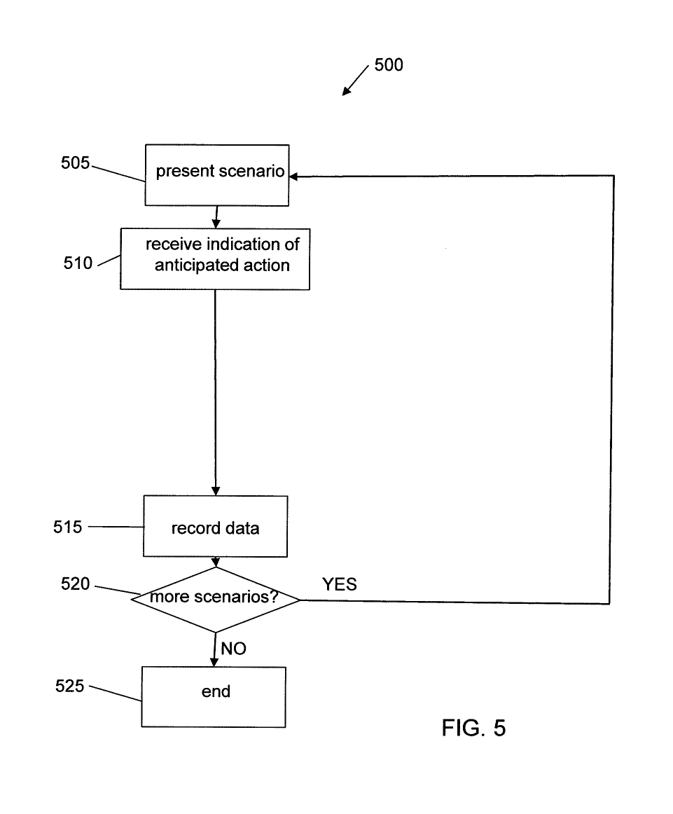

FIG. 5 shows an exemplary flow 500 for conducting (or running) an experiment (or study) in accordance with aspects of the present invention. At step 505, the scenario running tool presents a scenario to a test subject. At step 510, the scenario running tool receives a test subject's indication of anticipated action. At step, 515 the data collection tool saves (e.g., in storage system 22B of FIG. 1) the received data (e.g., the test subject's indication of anticipated action). At step 520, the scenario running tool determines whether the experiment (or study) includes additional scenarios. If, at step 520, the scenario running tool determines that the experiment (or study) includes additional scenarios, the process continues at step 505. If, at step 520, the scenario running tool determines that the experiment (or study) does not include additional scenarios, the process ends at step 525.

In embodiments, the VSL may utilize various licensing models, including, for example: (1) pay as you go; (2) site license (per researcher); and/or (3) a social media (e.g., Facebook) license, amongst other contemplated licensing models. For example, a user may purchase one of three types of licenses: per-subject, site license, a social media (e.g., Facebook) license. In the case of the first two licensing models, in embodiments, the purchaser may receive either a set number of test participants or a set number of user logins.

In accordance with aspects of the invention, with the pay as you go licensing option, administrators may purchase Participant Keys (PKs) in packs of, for example, 100, 250, 500, etc. (with, for example, prices discounted for higher numbers). With this exemplary embodiment, the PKs never expire (i.e., are not time-based). In embodiments, the administrator may create an unlimited number of researcher users and select how many PKs to assign to each (As should be understood, administrators can also be researchers, assigning PKs to themselves). In embodiments, researchers may create an unlimited number of scenarios, and can allow other researchers in the system access to their scenarios. In embodiments, researchers may assign their allotted PKs to scenarios (e.g., one Scenario could have 100 participants, while another scenario could have 200 participants, etc.). In embodiments, a scenario may end when the allotted number of participants completes the scenario(s), when it reaches a predefined end-date, or when the researcher ends it manually. In embodiments, if scenarios are ended before all PK's are used, remaining PK's may be put back into the researcher's available pool for other scenarios. In embodiments, researchers can invite an unlimited number of participants to each Scenario via email, but only the first X participants (up to the number of PKs assigned to that scenario) will be allowed to participate. After that, participants will get, for example, a “Study Closed” message.

In accordance with further aspects of the invention, with a site license (per-researcher), administrators may subscribe for a fixed number of researchers for a set amount of time (e.g., 3 researchers for a 6 month subscription period). With this exemplary embodiment, each researcher may access an unlimited number of scenarios and Participant Keys during their subscription period. In embodiments, prices may be discounted for more researchers. Additionally, in embodiments, different pricing may be provided for corporate versus educational accounts.

In accordance with further aspects of the invention, with a social media license users may sign-in via, for example, Facebook, for public scenarios. In embodiments, the social media option may not require secure keys to access.

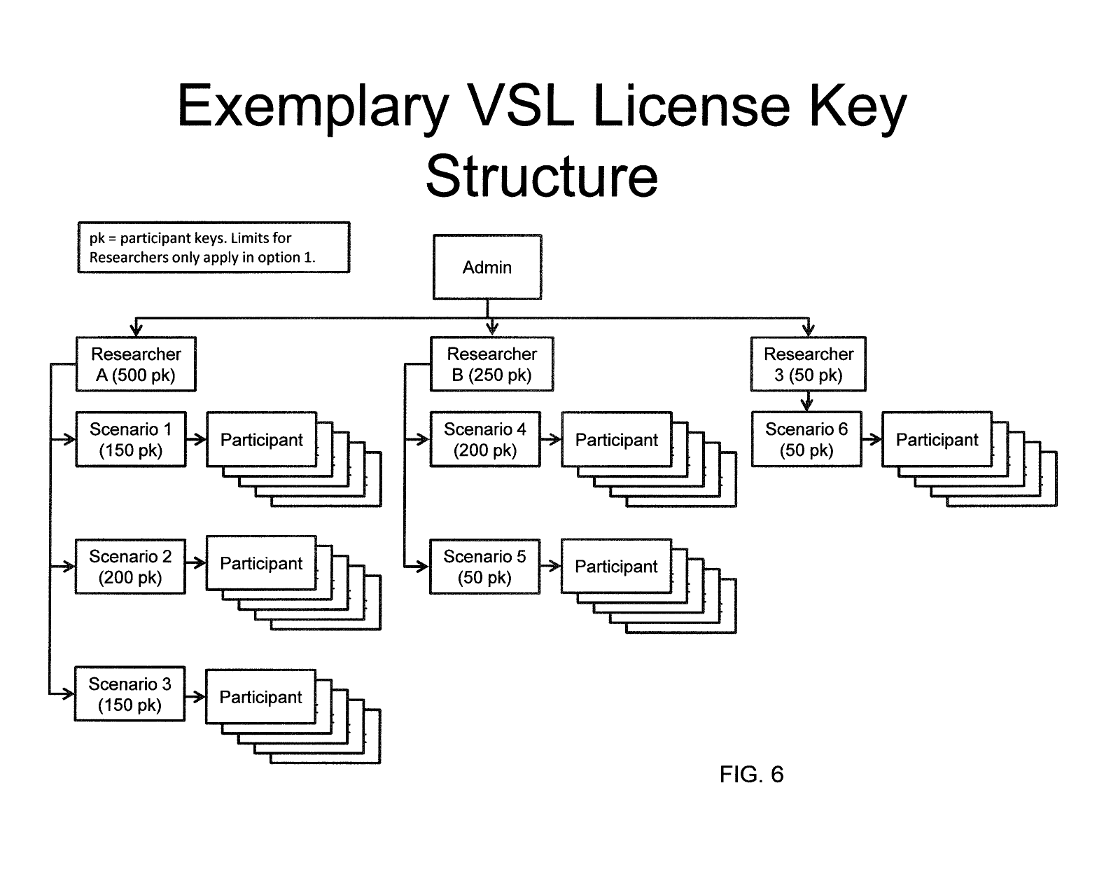

FIG. 6 illustrates an exemplary VSL license key structure in accordance with aspects of the invention. In accordance with aspects of the invention, a PK structure includes: [Account]: [Scenario]: [Participant]. PKs (or the participants associated with the PKs) are children of scenarios, which, in turn, are children of the Accounts. PKs can be used one time each. Each Account may have unlimited scenarios. Each scenario can have as many participants as it has PKs assigned to it by the researcher. In embodiments, the number of PKs available for an Account is based on their license. In embodiments, participants (e.g., test subjects) are invited to scenarios via email with a link to a scenario landing page. The participants are prompted to login with their email and to create a password. In embodiments, when the participants login, they are assigned a PK for that scenario.

In accordance with further aspects of the invention, in embodiments, after establishing a licensing model, a researcher may select the attributes of the virtual “avatars” that participants will see as well as the background context, video, audio, and textual information that will be displayed. In a given experiment, there might be 4 to 8 of these “scenarios,” and each scenario might have multiple trials (with the same participant). Data can be aggregated from trials, scenarios, participants, etc.

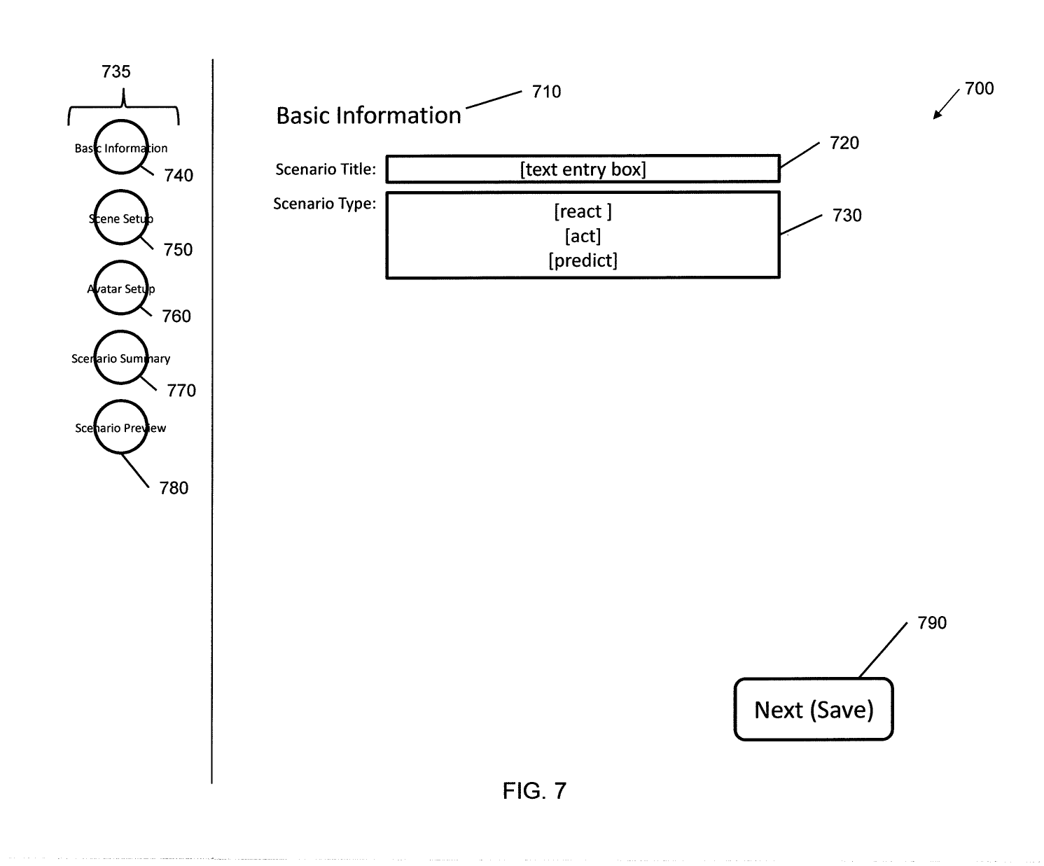

FIGS. 7-20 illustrate an exemplary wireframe that researchers, for example, may follow to create characters using an avatar creation system in accordance with aspects of the invention. The inventors note that the exemplary wireframe shown in FIGS. 7-20 is a non-limiting exemplary embodiment.

FIG. 7 illustrates an exemplary basic information page 700 in accordance with aspects of the invention. Using the basic information page 700, a researcher may assign a title for the scenario, choose scenario type, a method of Avatar selection, and/or whether to set an avatar accept rate for an entire group of avatars or per avatar subgroup.

As shown in FIG. 7, a “Basic Information” webpage title 710 indicates that a user is in the basic information stage of the scenario creation process. In accordance with aspects of the disclosure, the Scenario Title data field 720 (e.g., text box) allows a user to title the scenario. Using the Scenario Type data field 730 a user may choose what role the test subject will play in the virtual social interaction. For example, in “Act” scenarios, the test subject acts on the virtual avatars (e.g., deciding whether or not a virtual avatar “student” is suspended). In “React” scenarios, one or more virtual avatars act on the test subject (e.g., deciding whether the test participant is suspended), and the test subject's reaction is measured or observed, often after viewing other virtual avatars similarly acted on. In “Predict” scenarios, the test subject observes virtual avatars interacting (e.g., some avatar “students” are suspended by another avatar “school resource officer”), and then makes a prediction, for example, as to what may happen next in the scenario. It should be noted that, in embodiments, if the number of interactions is greater than a number of avatars, some avatars may appear more than once. In embodiments, if the number of interactions is less than a number of avatars, some avatars may not appear.

As shown in FIG. 7, in embodiments, the present invention includes a plurality of buttons/indicators 735 configured for selecting a page and indicating the selected page, wherein only one selection at a time is possible. The Basic Information button 740, when highlighted, indicates that the user is at the Basic Information stage of the scenario creation process. When not highlighted, the user may click on Basic Information button 740 in order to navigate to the Basic Information stage of the scenario creation process.

In accordance with additional aspects of the disclosure, the Scenario Setup button 750, when highlighted, indicates that the user is at Scenario Setup stage of the scenario creation process. When not highlighted, the user may click on the Scenario Setup button 750 in order to navigate to the Scenario Setup stage of the scenario creation process.

In accordance with additional aspects of the disclosure, the Avatar Setup button 760, when highlighted, indicates that the user is at Avatar Setup stage of the scenario creation process. When not highlighted, the user may click on the Avatar Setup button 760 in order to navigate to the Avatar Setup stage of the scenario creation process.

In accordance with additional aspects of the disclosure, the Scenario Parameters button 770, when highlighted, indicates that the user is at Scenario Parameters stage of the scenario creation process. When not highlighted, the user may click on the Scenario Parameters button 770 in order to navigate to the Scenario Parameters stage of the scenario creation process.

In accordance with additional aspects of the disclosure, the Scenario Preview button 780, when highlighted, indicates that the user is at Scenario Preview stage of the scenario creation process. When not highlighted, the user may click on the Scenario Preview button 780 in order to navigate to the Scenario Preview stage of the scenario creation process.

In accordance with additional aspects of the disclosure, the exemplary basic information page 700 also includes a Next (Save) Button 790. The user may click on the Next (Save) Button 790 button to save their work on this page and move to the next stage of the scenario creation process.

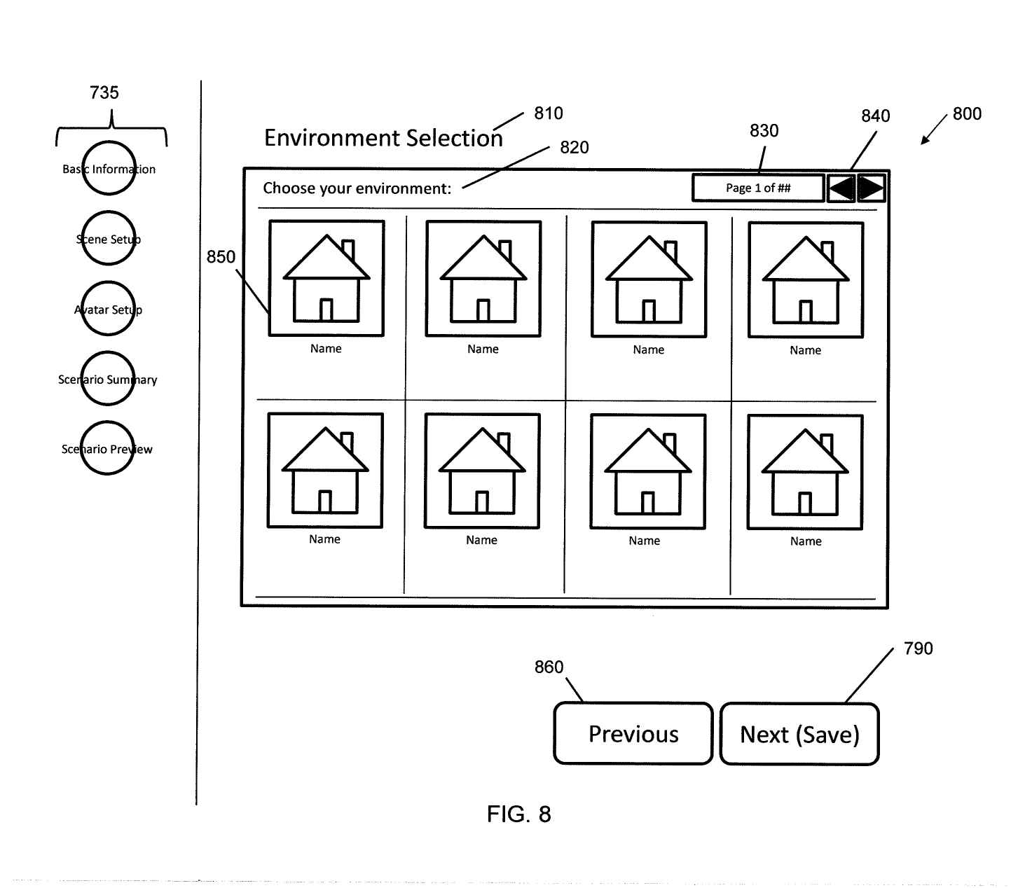

FIG. 8 illustrates an exemplary environment selection page 800. In accordance with aspects of the invention, using the environment selection page 800, a researcher may select an environment (or scene) for the scenario (e.g., by clicking a thumbnail of the environment).

As shown in FIG. 8, an “Environmental Selection” webpage title 810 indicates that a user is in the environment selection stage of the scenario creation process. The “Choose your environment:” statement 820 is an instruction to a user for this stage of the scenario creation process. The “Page 1 of ##” indicator 830 is an indication of how many pages of environments are available for the user to employ as a background to the scenario. By actuating the Left and right arrows 840, a user may view additional or previous pages of environments (e.g., backgrounds). The environment selection icons 850 allow a user to select the respective images as the environment (e.g., background) of the scenario (e.g., by clicking a thumbnail selection icon 850 of the environment). While the exemplary illustration shows these environment selection icons 850 as having the same image, it should be understood that these environment selection icons 850 may have different images corresponding to different environments. By actuating the previous button 860, a user may navigate to the previous stage of the scenario creation process.

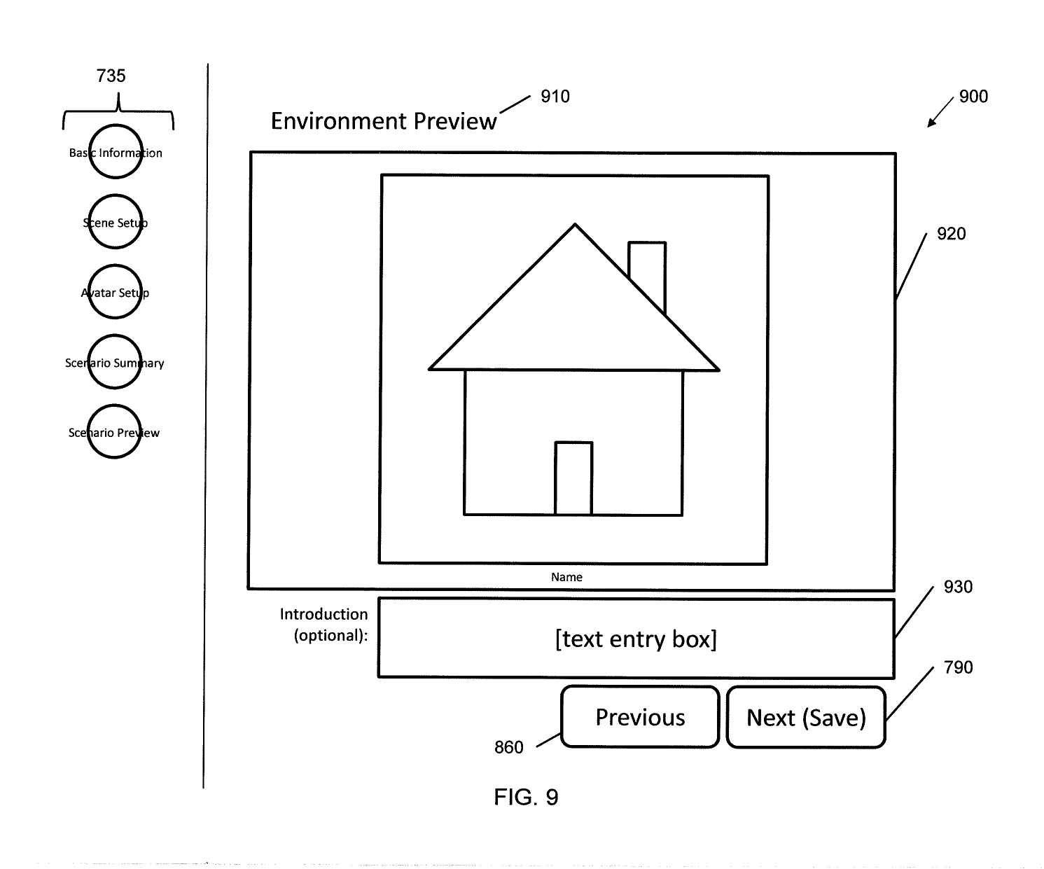

FIG. 9 illustrates an exemplary environment preview page 900 in accordance with aspects of the invention. Using the environment preview page 900, a researcher may preview an environment for the scenario. As shown in FIG. 9, an “Environmental Preview” webpage title 910 indicates that a user is in the environment preview stage of the scenario creation process. The preview window 920 displays a preview of the background image selected at the environmental selection stage (e.g., as shown in FIG. 8). The optional introduction text box 930 is a text box in which the user (e.g., the researcher) may input an introduction that will be seen by a test subject before the virtual social interaction in the scenario begins. For example, an introduction may state “Welcome to Washington High School. You are about to see information about a number of Washington High School's students. Please pay careful attention, and answer all subsequent questions honestly.”

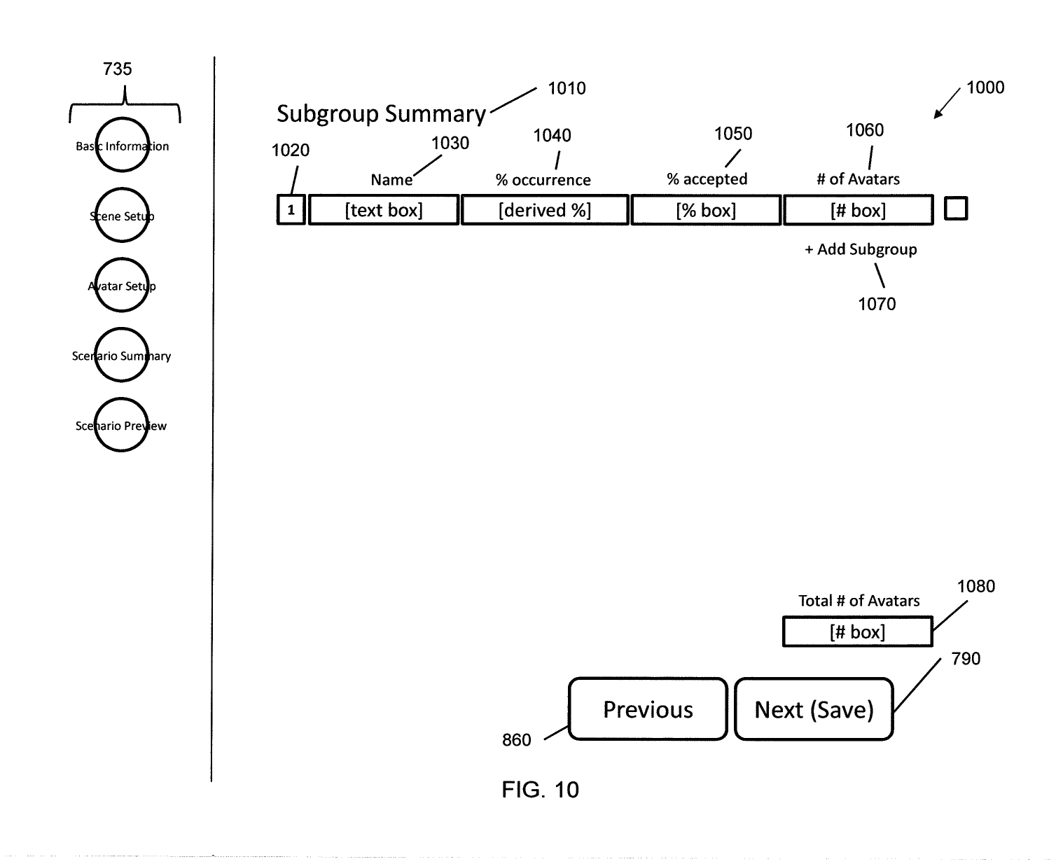

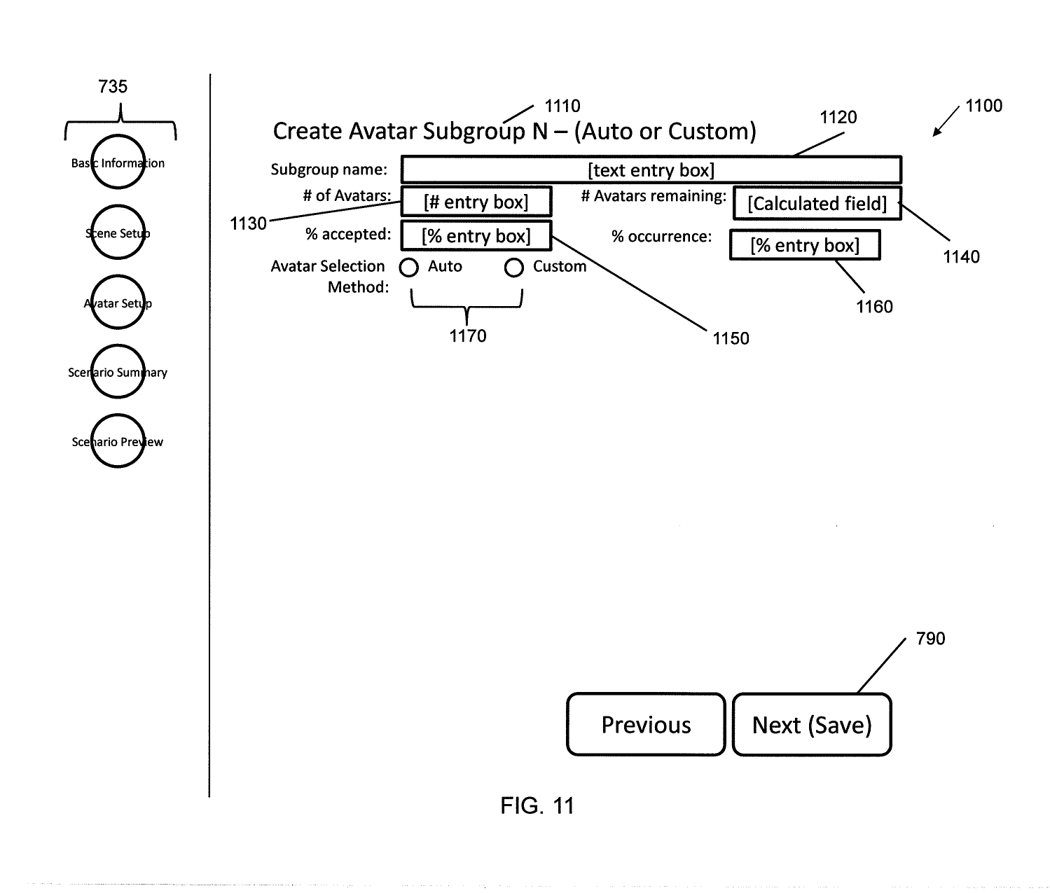

FIG. 10 illustrates an exemplary subgroup summary page 1000 in accordance with aspects of the invention. Using the environment preview page 1000, a researcher view and/or configure the subgroups for the scenario. As shown in FIG. 10, a “Subgroup Summary” webpage title 1010 indicates that a user is in the subgroup summary stage of the scenario creation process. As shown in FIG. 10, subgroup number column 1020 identifies a particular subgroup of the subgroups created by the user. It should be understood that with this exemplary and non-limiting embodiment, only one subgroup (i.e., subgroup 1) is shown. The name column 1030 identifies the names of all respective subgroups. The % occurrence column 1040 indicates how frequently the subgroup appears on screen during the scenario. The % accepted column 1050 indicates how often that subgroup is treated in one of the ways outlined by the user (e.g., “admitted” to a restaurant). The # of avatars column 1060 indicates the raw number of avatars in the respective subgroup. Additionally, the present disclosure may indicate the total number of avatars in the entire scenario (i.e., in all of the subgroups) in a total # of avatars indicator 1080 (e.g., at the bottom of the # of avatars column 1060). The subgroup summary page 1000 also includes an add subgroup button 1070, which permits the user to create various additional “subgroups,” for example, as described in FIG. 11.

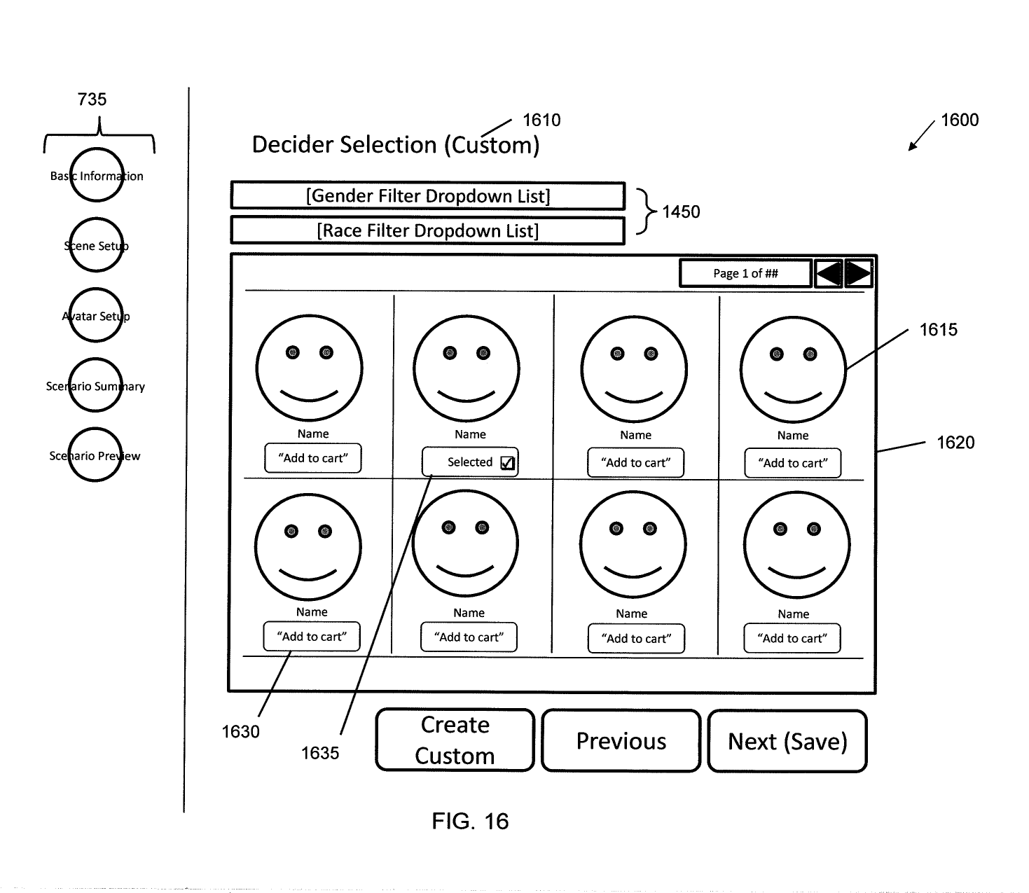

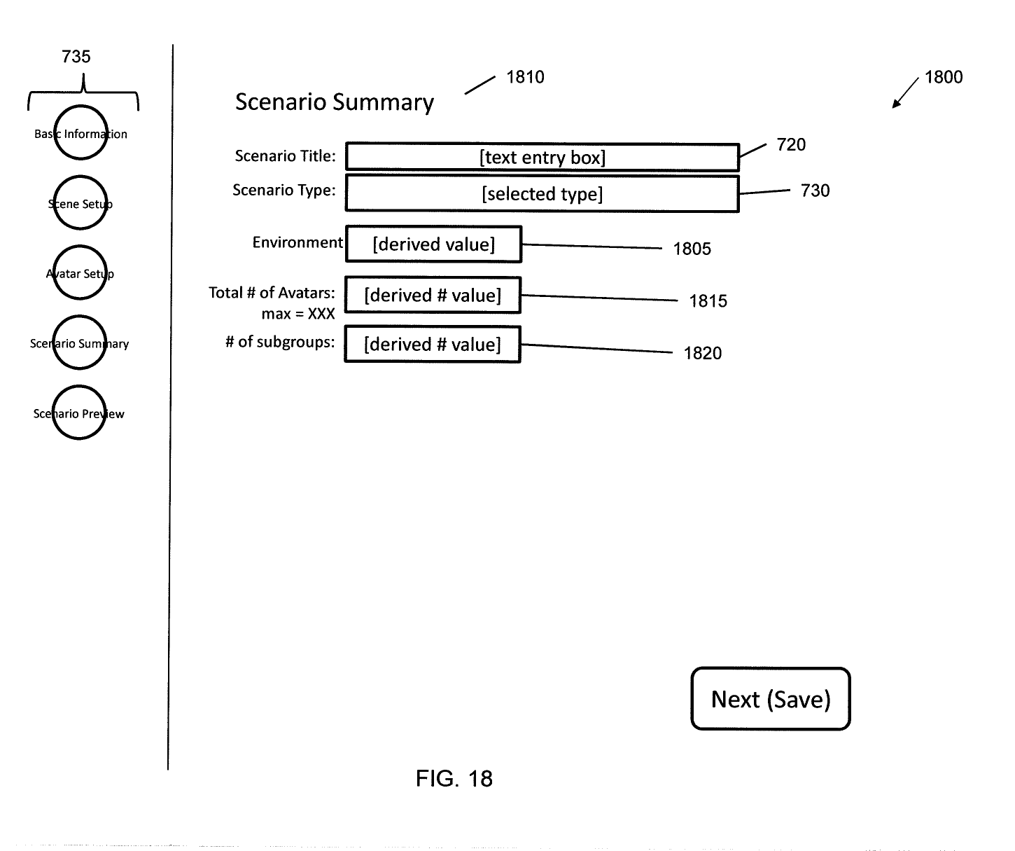

In embodiments, the subgroup summary page 1000 may initially appear with the add subgroup button only, which upon actuation, takes the user to the “Create Avatar Subgroup” page (discussed below with FIG. 11). The data in the fields of FIG. 10 (e.g., name, % occurrence, % accepted and # of avatars) are populated based on the data entered in the “Create Avatar Subgroup” stage. In embodiments, the next (save) button 790 may initially be grayed out until at least one subgroup is created. In embodiments, once the next (save) button 790 is no longer grayed out (i.e., a user has created at least one subgroup), actuating the next (save) button 790 may take the user to a later stage in the scenario creation process. For example, with a “react” or “predict” scenario, actuating the next (save) button 790 from the subgroup summary page 1000 may take the user to the decider selection page (described below with reference to FIG. 16). With an “act” scenario, actuating the next (save) button 790 from the subgroup summary page 1000 may take the user to the Scenario Summary page (described below with reference to FIG. 18).

FIG. 11 illustrates an exemplary create avatars subgroup page 1100 in accordance with aspects of the invention. As shown in FIG. 11, a “Create Avatar Subgroup N—(Auto or Custom)” webpage title 1110 indicates that a user is in the create avatar subgroup stage of the scenario creation process for subgroup N, (wherein N is the subgroup number). In accordance with aspects of the disclosure, using the create avatars subgroup preview page 1100, a user may select the parameters for one or more avatar subgroups and indicate whether each of the one or more subgroups will be automatically generated (e.g., randomly) or custom generated (as discussed below).

In accordance with aspects of the disclosure, using the subgroup name data entry field 1120, a user may name a given subgroup. Using the # of avatars data entry field 1130, a user may specify the raw number of avatars for a particular subgroup. The # of Avatars remaining data field 1140 indicates the number of avatars that are left to be assigned various characteristics. For example, if a user specifies that a given subgroup is to contain twenty avatars, and specifies that eight of the avatars should wear green shirts, the # Avatars remaining field 1140 will indicate “twelve.”

Using the % accepted data entry field 1150, a user may select how often a given subgroup is treated in one of the ways outlined by the user (e.g., “admitted” to a club). Using the % occurrence data entry field 1160 a user may select how frequently the subgroup appears on screen in the scenario during the scenario.

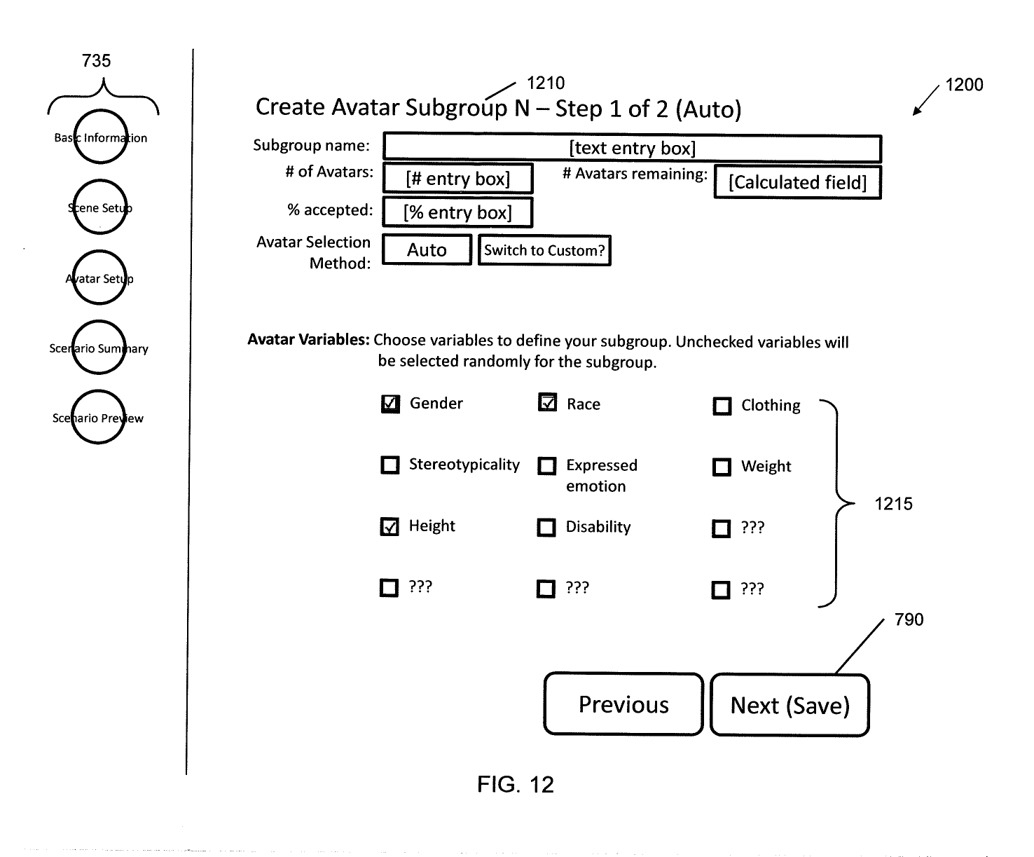

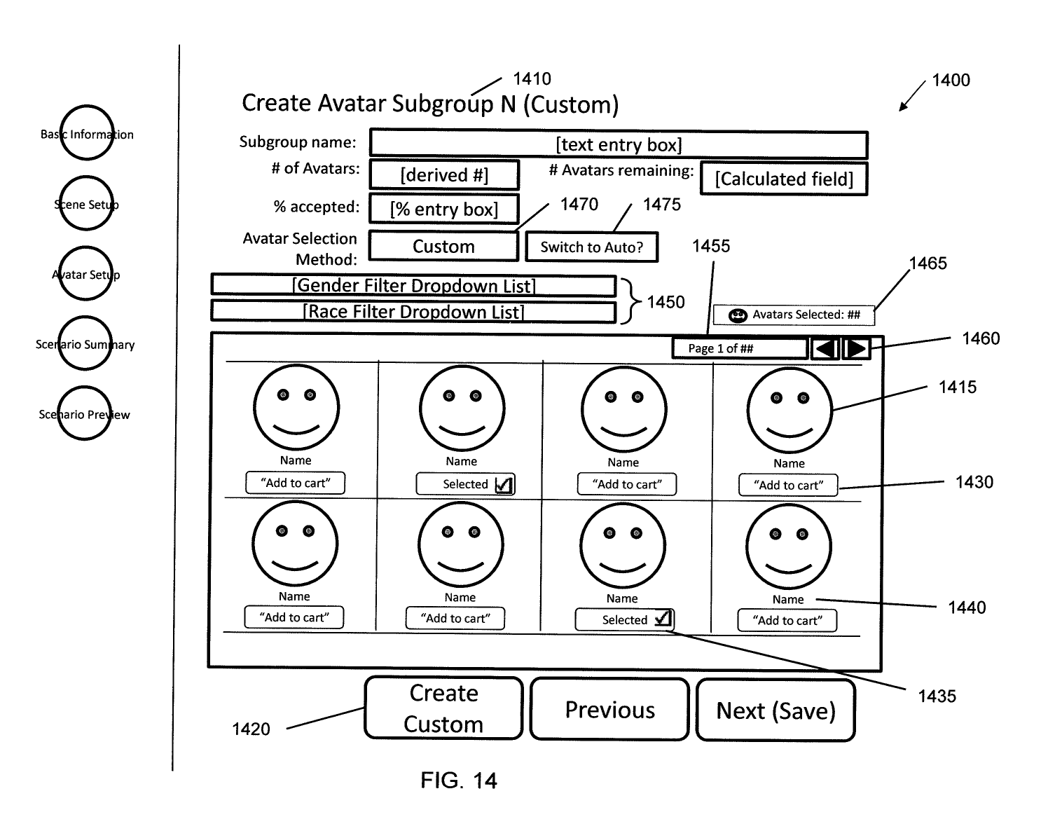

Additionally, with this exemplary embodiment, the create avatars subgroup page 1100 is configured to receive a user's selection of whether the subgroups will be automatically generated or custom generated. For example, in accordance with additional aspects of the invention, using the avatar selection method selector 1170, the user may choose whether s/he would prefer to select avatars individually (i.e., custom), or at random (i.e., auto) based on a range of criteria (e.g., shirt color, gender, etc.). If custom is selected, (as is shown with this exemplary embodiment), pressing the next (save) button 790 will take the user (e.g., researcher) to the custom avatar subgroup page (which is discussed below with reference to FIG. 14). If auto is selected, an additional interface element becomes active (which is discussed below with reference to FIG. 12).

FIG. 12 illustrates an exemplary auto create avatars subgroup page 1200 with an avatar variables selection interface 1215 in accordance with aspects of the disclosure. As shown in FIG. 12, a “Create Avatar Subgroup N—Step 1 of 2 (Auto)” webpage title 1210 indicates that a user is in the auto create avatar subgroup stage of the scenario creation process for subgroup N, (wherein N is the subgroup number). In other words, FIG. 12 illustrates the create avatars subgroup page similar to that shown in FIG. 11 with the above-mentioned additional interface element (i.e., the avatar variables selection interface 1215) in accordance with aspects of the disclosure. The avatar variables selection interface 1215 outlines the variables (e.g., gender, race, clothing, stereotypicality, expressed emotion, weight, height, disability, amongst other contemplated variables, such as sexual orientation) by which a user can sort avatars when selecting them using the “auto” function. For example, if a user chooses “gender,” “race,” and “height,” in the avatar variables selection interface 1215, the user is permitted to specify how many avatars of each gender, race, and height specifications they would like this subgroup to contain. If any variables are unchecked, the present system is operable to select those variables randomly for the subgroup.

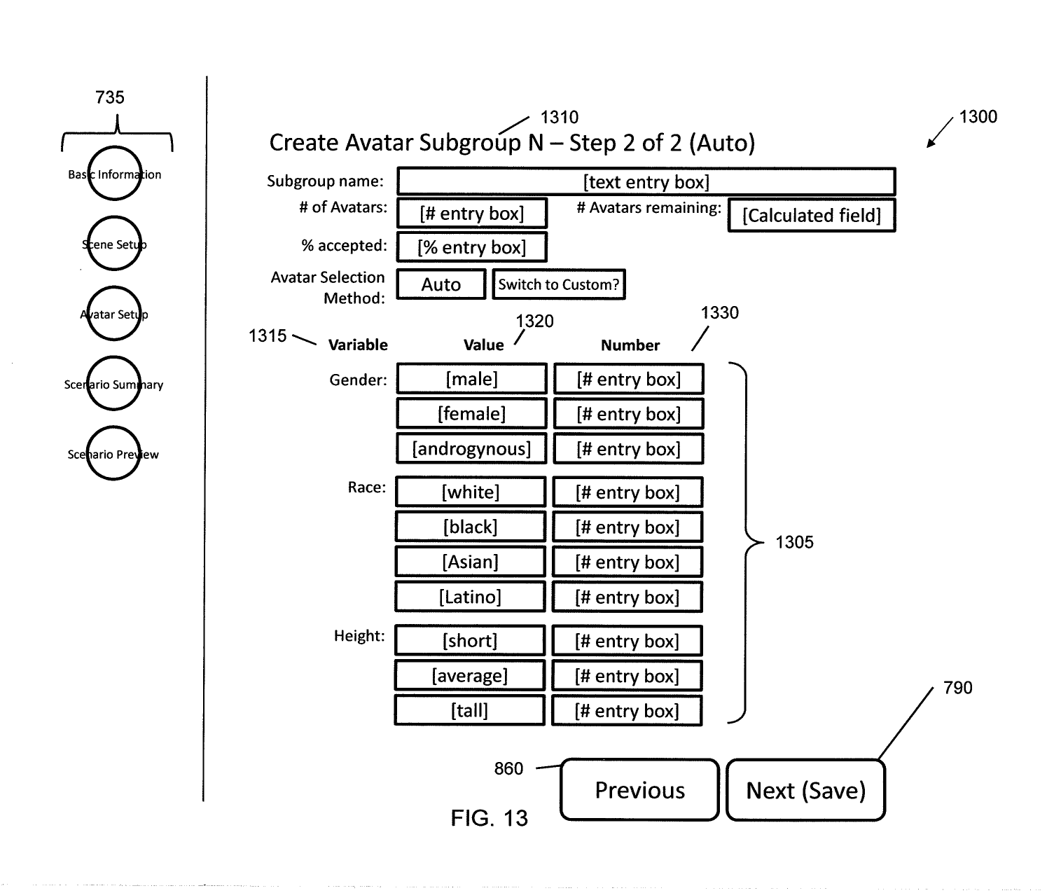

FIG. 13 illustrates an exemplary auto create avatars subgroup page 1300 with an avatar variables setting interface 1305 in accordance with aspects of the disclosure. As shown in FIG. 13, a “Create Avatar Subgroup N—Step 2 of 2” webpage title 1310 indicates that a user is in the create avatar subgroup stage of the scenario creation process for subgroup N (wherein N is the subgroup number).

In accordance with aspects of the disclosure, using the create avatars subgroup preview page 1300, a user may select the values for the variables selected in the avatar variables selection interface 1215 (shown in FIG. 12). For example, the avatar variable setting interface 1305 includes all those variables selected in the avatar variable selection interface 1215 indicating which avatar-specifying variable the user must specify and identifies possible values for each variable. With an exemplary embodiment, with reference to the gender variable, possible values include “male,” “female,” and “androgynous.” While the exemplary embodiment lists values for each of the variables, it should be understood that the exemplary embodiment is non-limiting, and the disclosure contemplates other variables.

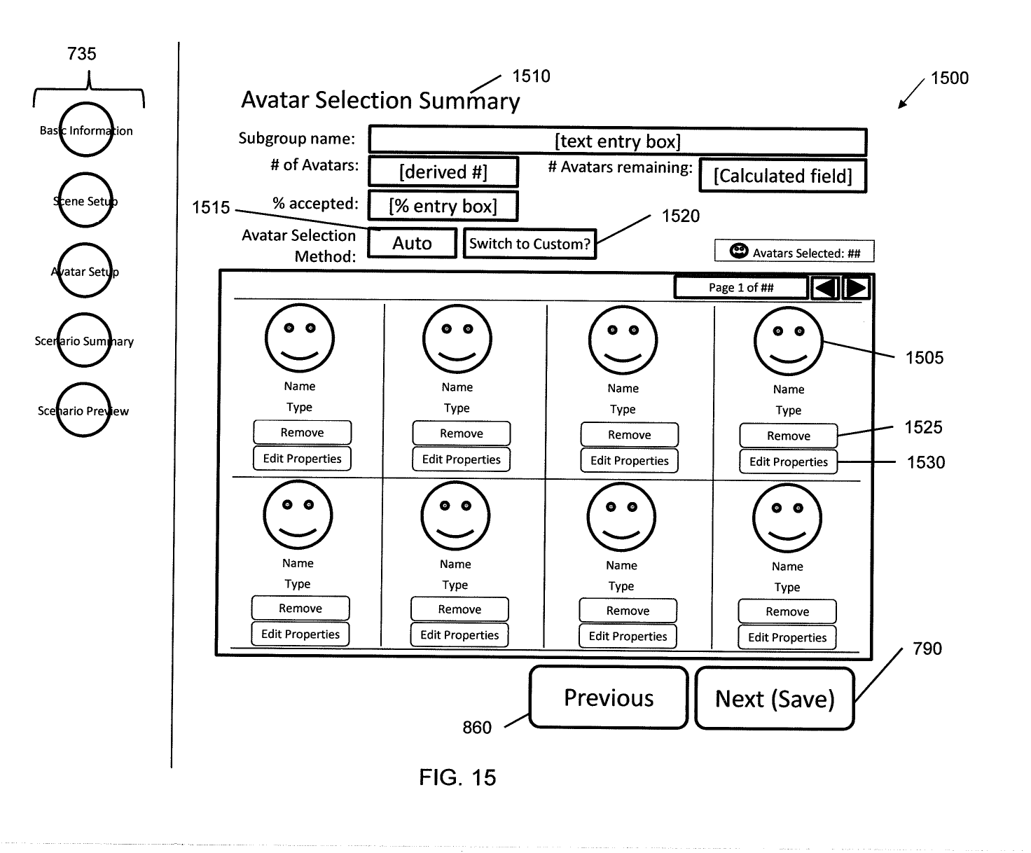

As shown in FIG. 13, in embodiments, the avatar variable setting interface 1305 includes a variable column 1315, which lists those variables selected in the avatar variables selection interface 1215 (shown in FIG. 12). Additionally, the avatar variable setting interface 1305 includes a value column 1320, which lists the possible values for each variable, and is configured to receive a user's specification how many avatars of each variable type the user would like for a particular scenario. Furthermore, the avatar variable setting interface 1305 includes a % occurrence column 1330, which is configured to receive a user's specification as to how frequently avatars having the corresponding variable values within this subgroup appear on screen during the scenario. After receiving the information in the avatar variable setting interface 1305, upon actuation of the next (save) button 790, the system is operable to proceed to the avatar selection summary page (discussed below with reference to FIG. 15).

FIG. 14 illustrates an exemplary custom create avatars subgroup page 1400 for a custom avatar selection in accordance with aspects of the invention. As shown in FIG. 14, a “Create Avatar Subgroup N (Custom)” webpage title 1410 indicates that a user is in the custom create avatar subgroup stage of the scenario creation process for subgroup N, (wherein N is the subgroup number). As should be understood, the custom create avatars subgroup page 1400 may be accessed if the custom avatar selection is selected on the create avatar subgroup page 1100 (as shown in FIG. 11).

As shown in FIG. 14, the custom create avatars subgroup page 1400 includes avatar icons 1415 (shown in this example as smiley faces), which, upon actuation, provides a preview of the selected avatar to the user. For example, clicking on an avatar icon 1415 may provide a full body preview of the selected avatar. The “add to cart” button 1430 is operable to select a given avatar for the scenario being built. As shown in FIG. 14, upon selection, the “add to cart” button 1430 may change to a “selected” indicator 1435, indicating that the particular avatar has been selected for the scenario being created. The avatars selected indicator 1465 indicates the total number of avatars currently selected (e.g., using the “add to cart” button 1430) for the given subgroup. The name field 1440 is operable to display a name of the respective avatar (e.g., a user-configurable name).

As shown in FIG. 14, the custom create avatars subgroup page 1400 also includes one or more user selectable filters 1450 (e.g., a gender filter or a race filter), for example, embodied as one or more drop-down lists, which are operable to filter the available avatars. For example, if a user would like to select from only female avatars, the user may utilize a filter 1450 to limit those displayed avatar icons 1415 to female avatars. The “Page 1 of ##” indicator 1455 is an indication of how many pages of avatars are available for the user to employ in the scenario. By actuating the left and right arrows 1460, a user may view additional or previous pages of avatar icons 1415. The avatar selection method indicator 1470 is operable to display the selected avatar creation method (e.g., custom). The switch to auto button 1475 is operable to switch from the currently selected custom avatar generation method to an auto avatar generation method.

In accordance with additional aspects of the disclosure, the “create custom” button 1420 is operable to create one or more custom avatars to be used in the scenario based on the selected avatar icons 1415. The selected avatars will be locked out in the “decider selection” page (discussed below with reference to FIG. 16). That is, because a “decider” avatar cannot also appear in the avatar group (i.e., any of the avatar subgroups), in embodiments, the avatars displayed as available for selection in the decider selection area will exclude avatars already include in the scenario (discussed below with reference to FIG. 16).

FIG. 15 illustrates an exemplary avatar selection summary page 1500 in accordance with aspects of the invention. The avatar selection summary page 1500 is operable to summarize the selected avatars 1505 for a given subgroup (for example, those avatars selected using the custom create avatars subgroup page 1400). As shown in FIG. 15, the “Avatar Selection Summary” webpage title 1510 indicates that a user is in the avatar selection summary of the scenario creation process.

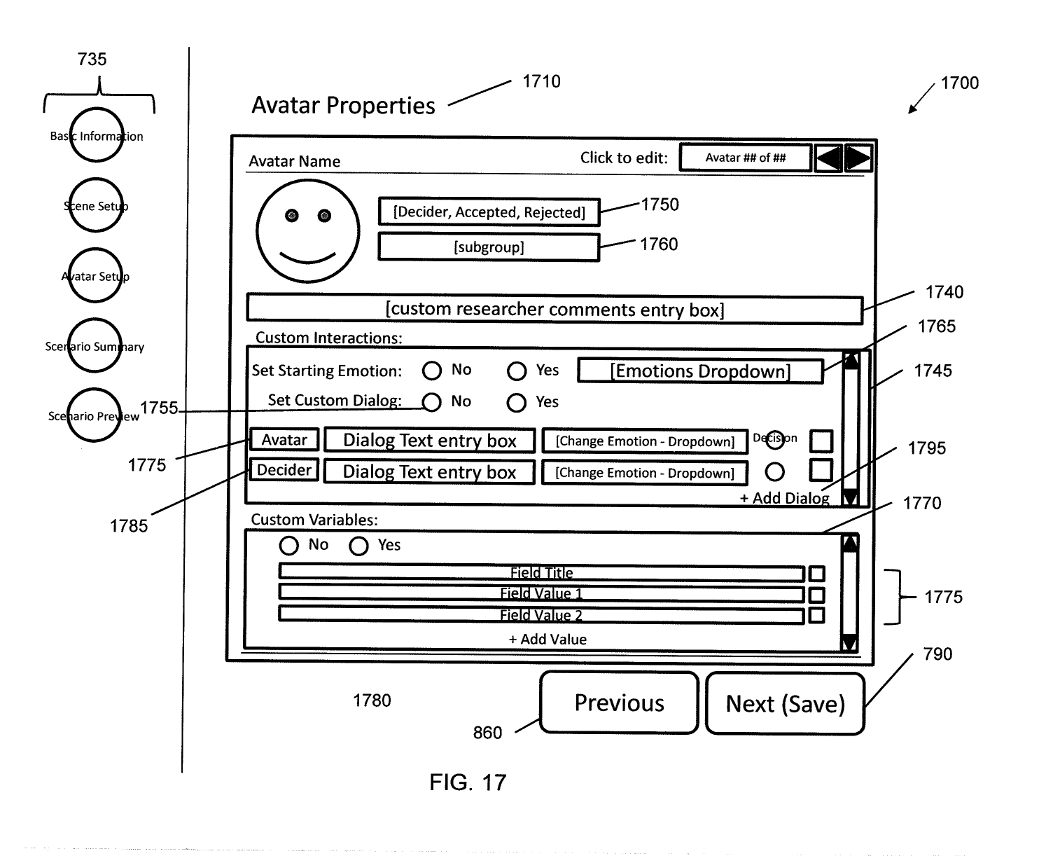

In accordance with aspects of the disclosure, a user may switch between automatic avatar creation process to a custom avatar creation process (and vice versa) via the avatar selection summary page 1500. For example, if the selection method has been set to “auto” (as indicated at 1515), the avatar selection summary page 1500 may include a “Switch to Custom” button 1520. Upon actuation of the “Switch to Custom” button 1520, the user is presented with the custom create avatars subgroup page 1400 (shown in FIG. 14). In embodiments, the avatar selection summary page 1500 also includes for each avatar of the selected avatars 1505, a “remove” button 1525 and an “edit properties” button 1530. The remove button 1525 is operable to remove a respective avatar from the scenario being built. The “edit properties” button 1530 is operable to, upon actuation, present the avatar properties page (discussed below with reference to FIG. 17), wherein the user may make custom edits to the avatars (e.g., customize the look of the selected avatar). Actuating the next (save) button 790 presents the user with the subgroup summary page 1000 (as shown in FIG. 10).

FIG. 16 illustrates an exemplary decider selection page 1600 in accordance with aspects of the disclosure. The decider selection page 1600 is accessed if either the “react” or the “predict” scenario type is selected on the basic information page 700 (shown in FIG. 7). As shown in FIG. 16, the “Decider Selection (Custom)” webpage title 1610 indicates that a user is in the decider selection stage for a custom avatar scenario creation process.

In accordance with aspects of the invention, the decider selection page 1600 is operable to receive a selection of one or more “decider” avatars. The available “decider” avatars are displayed as avatar icons 1615 in the avatar decider selection area 1620. In embodiments, because a “decider” avatar cannot also appear in the avatar group (i.e., any of the avatar subgroups), the avatars (e.g., avatar icons 1615) displayed as available for selection in the decider selection area 1620 will exclude avatars already include in the scenario. In accordance with aspects of the disclosure, the “add to cart” button 1630 is operable to select a given avatar as a “decider” avatar. As shown in FIG. 16, upon selection, the “add to cart” button 1630 may change to a “selected” indicator 1635, indicating that the particular avatar has been selected as a “decider” avatar. As discussed above, a “decider” avatar may be used in a “react” or “predict” scenario as the avatar that is the primary actor during a scenario (e.g., makes the decisions about who is and who is not suspended from school).

FIG. 17 illustrates an exemplary avatar properties page 1700 in accordance with aspects of the invention. The avatar properties page 1700 is accessed when a user actuates an “edit properties” button (e.g., “edit properties” button 1530 shown in FIG. 15). As shown in FIG. 17, the “Avatar Properties” webpage title 1710 indicates that a user is in the edit avatar properties stage of the avatar scenario creation process. In accordance with aspects of the disclosure, the avatar properties page 1700 is configured to receive user selections for one or more properties of a given avatar. Additionally, the avatar properties page 1700 allows a user to define chat scripting for each avatar in the scenario. For example, each avatar may have a customizable conversation with the “decider” avatar as each respective avatar reaches the front of queue.

As shown in FIG. 17, the avatar properties page 1700 also includes an “Avatar ## of ##” field and associated buttons 1720, which, upon actuation, are operable to permit a user to edit the order of the a selected avatar in a scenario (e.g., where this avatar is within a queue of avatars awaiting admittance into a club). The avatar properties page 1700 also includes an avatar icon 1730, which, upon actuation, is operable to display a preview picture of a given avatar. The text field 1740 is configured to receive user comments (e.g. to make notes on a given avatar). The avatar type field 1750 permits the user to designate the type of the avatar, e.g., whether a given avatar will be a “decider” avatar, i.e., the avatar making decisions within a scenario (e.g., as a school administrator suspending students, or as a bouncer preventing or granting access to a bar), an “accepted” avatar (e.g., a non-suspended student, or a person granted access to a bar), or a “rejected” avatar (e.g., a suspended student, or a person denied access to a bar).

In accordance with additional aspects of the disclosure, the subgroup field 1760 permits the user to designate (or change) which (if any) subgroup a particular avatar belongs to. The custom variables section 1770 permits the user to designate whether or not this scenario will be permitted to employ one or more custom variables (e.g., a Philadelphia Phillies™ jersey on the avatar, or a particular hair color). Additionally, the custom variables section 1770 includes field title and field values, which allow for naming and defining the custom variable. The add value button 1780 allows a user to add additional custom variables. In embodiments, variables enabled for one avatar will be available for all of the other avatars in the scenario. In accordance with aspects of the disclosure, the custom variables section 1770 accommodates the need for researchers to set their own custom attributes to track and report on. If a researcher chooses to utilize custom variables, the information entered in the custom variables section 1770 would appear in the avatar selection summary page 1500 (shown in FIG. 15). These custom attributes may be stored in a database (e.g., storage system 22B of FIG. 1), which may be specific to the customized scenario.

In accordance with additional aspects of the disclosure, the custom interactions section 1745 allows a user to configure custom interactions (e.g., avatar starting emotions and/or custom dialogs between avatars). As shown in FIG. 17, in embodiments, the custom interactions section 1745 includes “yes” and “no” radio buttons 1755 for selecting custom starting emotions and/or custom dialogs. In other embodiments, dropdown menus may be used instead of the “yes” and “no” radio buttons 1755. The custom interactions section 1745 also includes an emotions selection field 1765 (e.g., a dropdown menu). In accordance with aspects of the disclosure, using custom dialogs permits the user to script dialogue, for example, between a given avatar and that avatar's interaction partner (e.g., a “decider” avatar). The avatar section 1775 permits the user to script conversation for a given avatar and/or change emotions of the avatar (e.g., after performing the dialog). The decider section 1785 permits the user to script conversation for a given avatar's conversation partner (e.g., a decider) and/or change emotions of the conversation partner avatar (e.g., after performing the dialog). The add dialog button 1795 permits the user to add additional lines of dialogue the avatar and/or the conversation partner. In other contemplated embodiments, a dialog set-up page for the entire group (not shown) may be utilized to configure the custom interactions.

FIG. 18 illustrates an exemplary scenario summary page 1800 in accordance with aspects of the invention. As shown in FIG. 18, the “Scenario Summary” webpage title 1810 indicates that a user is in the scenario summary stage of the avatar scenario creation process. In accordance with aspects of the disclosure, the scenario summary page 1800 provides a scenario recap, which the user can review before running the final scenario preview. As shown, in embodiments, the scenario summary page 1800 includes the scenario title 720, the scenario type 730, as selected by the user on the basic information page 700. Additionally, the scenario summary page 1800 includes the scenario environment 1805, as selected by the user on the environment selection page 800. Further, the scenario summary page 1800 includes the total number of avatars in the scenario 1815, and a number of subgroups in the scenario 1820 (as determined by the user with one or more of the pages illustrated in FIGS. 10-16). Additional details regarding the scenario can be added by the user, as desired.

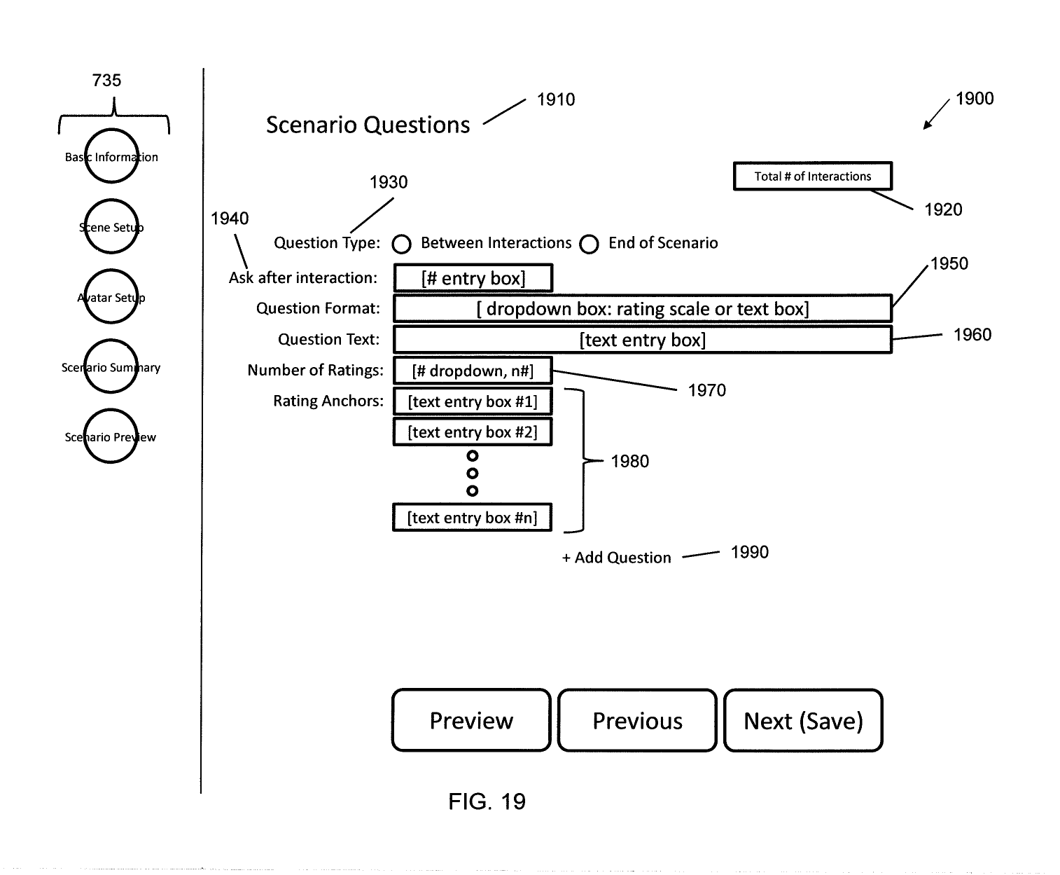

FIG. 19 illustrates an exemplary scenario questions page 1900 in accordance with aspects of the disclosure. As shown in FIG. 19, the “Scenario Questions” webpage title 1910 indicates that a user is in the scenario questions stage of the avatar scenario creation process. In accordance with aspects of the disclosure, the scenario summary page 1900 allows the user to configure, for example, the content and timing of questions to ask the viewer of the scenario (e.g., the test subject).

As shown in FIG. 19, the exemplary scenario questions page 1900 includes a “total # of interactions” field 1920, which indicates the total number of interactions the test subject will view during the scenario. The question type selector 1930 allows a user to configure the timing of questions to the test subject, for example, as between interactions of the avatars, or at the end of the scenario. The “ask after interaction” field 1940 allows a user to configure the timing of the questions, for example, to be after a user-selected number of interactions. For example, in embodiments, a user may configure the study to allow a test subject to observe a certain number of avatar interactions before beginning to ask the test subject any questions. The question format field 1950 allows the user to configure the question (and answer) format (e.g., as selecting an answer from a dropdown box, answering as a rating on a rating scale, or answering in a text format).

The question text field 1960 permits the user to script a question to be asked of the test subject during the scenario. For example, a question may be “Do you think the bouncer will let this patron in?” The number of ratings field 1970 allows the user to configure a number of selectable ratings in the rating scale. The rating anchors fields 1980 allow the user to assign text descriptions to the different ratings in the ratings scale (“1=very unlikely; 2=somewhat unlikely; 3=possibly unlikely/possibly likely; 4=somewhat likely; and 5=very likely). The add question button 1990 is operable to permit the user to add one or more additional questions, which may be specified as described above.

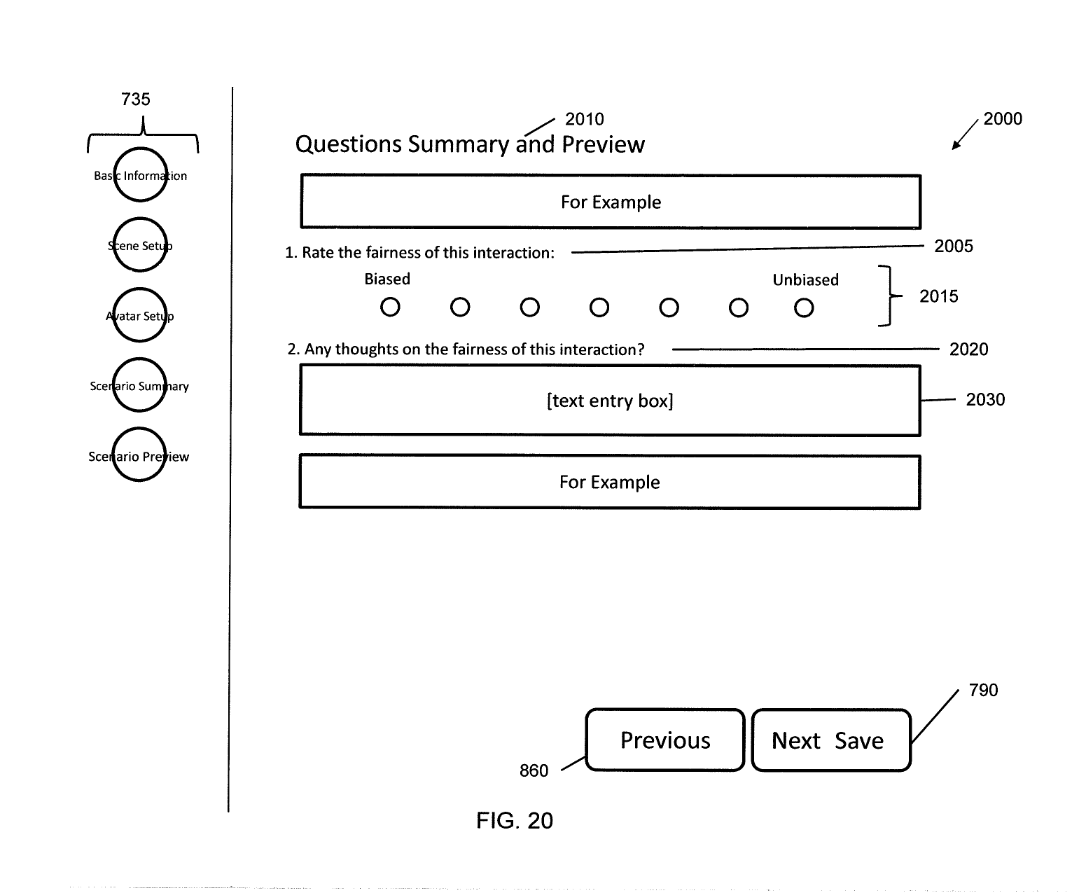

FIG. 20 illustrates an exemplary questions summary and preview page 2000 in accordance with aspects of the disclosure. As shown in FIG. 20, the “Questions Summary and Preview” webpage title 2010 indicates that a user is in the questions summary and preview stage of the avatar scenario creation process. In accordance with aspects of the disclosure, the questions summary and preview page 2000 allows the user to preview the one or more questions to ask the viewer of the scenario (e.g., the test subject).

As shown in FIG. 20, the exemplary questions summary and preview page 2100 includes a rating question 2005 with an answer selection area 2015 for receiving a test subject's rating. Additionally, the exemplary questions summary and preview page 2100 includes an open question 2020 with an text entry area 2030 for receiving a test subject's answer.

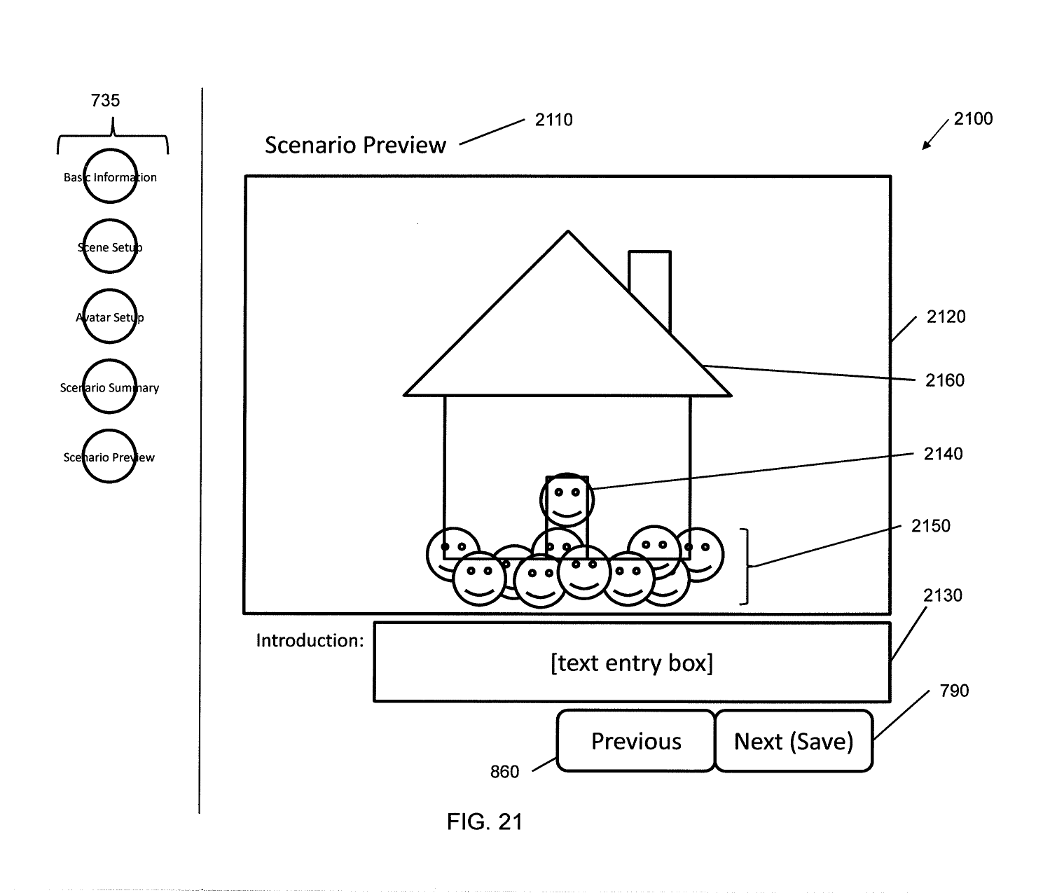

FIG. 21 illustrates an exemplary scenario preview page 2100 in accordance with aspects of the disclosure. As shown in FIG. 21, the “Scenario Preview” webpage title 2110 indicates that a user is in the scenario preview stage of the avatar scenario creation process. In accordance with aspects of the disclosure, the scenario preview page 2100 allows the user to preview the scenario.

As shown in FIG. 21, in embodiments, a preview image 2120 may include a rendering of all selected avatars (e.g., a decider avatar 2140 and one or more avatars 2150) and the background 2160 the user selected during the scenario creation process, e.g., as described above. For example, as shown in FIG. 21, with this exemplary scenario, a decider avatar 2140 is positioned to grant or deny the one or more avatars 2150 access to a building within the background 2160 (e.g., an establishment). An introduction field 2130 allows the user to script text that will appear, for example, after the test subject sees the background and/or the avatars, but before (e.g., immediately before) the test subject begins to interact with the avatars and/or observe the avatars interacting with each other. While the exemplary scenario preview page 2100 includes a preview image 2120 having all selected avatars, in embodiments, the preview image may include less than all the selected avatars for a particular scenario. For example, in embodiments, a preview image may include only the decider avatar 2140, or only the one or more avatars 2150.

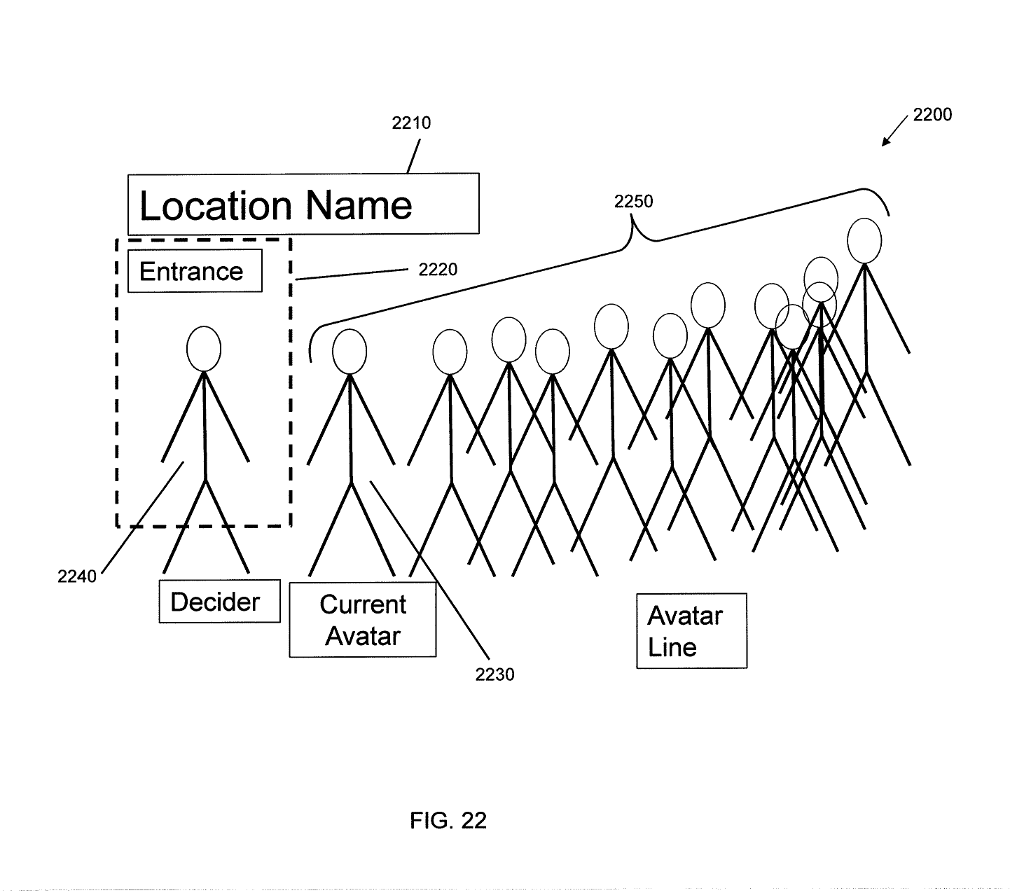

FIG. 22 illustrates an exemplary scenario environment 2200 in accordance with aspects of the disclosure. As shown in FIG. 22, the exemplary scenario environment 2200 includes a location (e.g., a bar) having a location name 2210 and an entrance to the location 2220. A decider avatar 2240 (e.g., a bouncer) is configured to grant or deny admittance to the respective avatars 2250 in the avatar line. The current avatar 2230 is currently in the process of being admitted or rejected by the decider avatar 2240.

Embodiments of the invention are directed to configuring a VSL scenario. A VSL scenario may be customizable by the user, and may be configured to collected test subject data on explicit attitudes (as with an online survey), on implicit attitudes (such as the Implicit Association Test, and on virtual interactions, in which the test subject can be positioned either as an observer or an active participant. This virtual interaction allows VSL to mimic social situations and receive information from test subjects without the burden of recruiting test subjects to a specific physical location. Using virtual avatars also allows the use greater control over the parameters of the social situation, allowing for tighter internal experimental validity.

Because the present invention permits the presentation of images, sound, and movies, it permits a wider range of data collection options than any other broadly available software package and allows, for the first time, for most kinds of psychological/attitudinal/intergroup measures to be collected all in one place, and virtually.

Embodiments of the invention are directed to running the VSL scenario for a test subject. Once the user has customized one or more scenarios, VSL permits the user to broadcast that scenario to specific individuals and/or to a wide range of individuals via websites (i.e., a company website, social networking sites such as Facebook®, or dedicated subject recruitment websites such as Amazon.com's® Mechanical Turk®). Test subjects can then click on a URL link provided to them via email, a website, or type in that URL link to a browser, and VSL will permit a predetermined number of test subjects to complete the customized scenario.

In embodiments, test subject inputs may be received based on the VSL scenario. In embodiments, the VSL is designed to store test subject input that the user may access once participants have completed the scenario. These data will be stored, for example in a spreadsheet format so that standard and advanced statistical analytic techniques may be performed on them. Test subject inputs may include (but shall not be limited to), for example, responses on a scale, reaction time latencies (e.g., how long it takes a test subject to indicate a response), vocal recordings of the test subject, visual recordings of the test subject, and biological indicators of the subject (e.g., blood pressure, neurological signals), provided the user has proper equipment with which to capture these data.

In embodiments, analyzing test subject input may include basic means testing and signal detection analyses, which may be automated should the user wish, meaning that, in addition to individual test subject data, users may be provided with a minimum of instant analyses of their findings. In addition, using unique subject identifiers, users may track individual test subjects, meaning that changes in test subject responses may be monitored and compared over time.

In embodiments, users may elect to store their test subject input for a predetermined period of time, reducing the burden on users' data storage capacities.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims, if applicable, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principals of the invention and the practical application, and to enable others of ordinary skill in the art to understand the invention for various embodiments with various modifications as are suited to the particular use contemplated. Accordingly, while the invention has been described in terms of embodiments, those of skill in the art will recognize that the invention can be practiced with modifications and in the spirit and scope of the appended claims.

What is claimed is:

1. A method implemented in a computer infrastructure having computer executable code tangibly embodied on a computer readable medium, comprising:
configuring a virtual social lab (VSL) scenario using a processor of a computing device;
running the VSL scenario for at least one test subject;
receiving test subject input based on the VSL scenario; and
storing the test subject input.

2. The method of claim 1, wherein the running the VSL scenario for the at least one test subject is performed without the at least one test subject being physically present in a controlled laboratory setting.

3. The method of claim 1, wherein the running the VSL scenario comprises randomly assigning two or more test subjects to the VSL scenario, at least two of the two or more test subjects located in different respective locations, and
wherein the receiving the test subject input comprises receiving the test subject input from the different respective locations.

4. The method of claim 1, wherein the running the VSL scenario for the at least one test subject comprises utilizing a social network website.

5. The method of claim 1, wherein the VSL scenario comprises an animated scene depicting one or more interactions between at least two characters in an environment.

6. The method of claim 5, wherein the environment comprises at least one of a nightclub, a restaurant, a police station, a government building, a school, an office building, an airport security line, a classroom, and an emergency room.

7. The method of claim 5, wherein the at least two characters comprise a decider character with authority to grant or deny access within the environment, and one or more characters seeking the access within the environment.

8. The method of claim 5, wherein the receiving the test subject input based on the VSL scenario comprises receiving at least one of an indication of a test subject's comfort with the interaction, an indication of the test subject's anticipation of what will happen next in the interaction, and a decision to grant or deny one of the at least two characters access within the environment.

9. The method of claim 1, wherein the receiving the test subject input based on the VSL scenario comprises receiving at least one of: a real-time indication, a survey response, biometric information, and a reaction time indication.

10. The method of claim 1, wherein the configuring the VSL scenario comprises configuring one or more parameters selected from: a number of interactions, a user input mode, an environment, a reject/accept ratio, and a percentage of occurrence of one or more character variables.

11. The method of claim 10, wherein the one or more character variables comprise at least one of: a gender, a race, a weight, a height, clothing, a degree of stereotypicality of skin tone, masculinity-femininity, an emotion on a character's face, an emotional expression indicated on (or by) a character's body, a gait, a voice, a disability, a usage of jewelry, a hairstyle, a personalization, an eye gaze, and a custom variable.

12. The method of claim 1, wherein the configuring the VSL scenario comprises selecting a test subject perspective from one of: a 3^{rd} person perspective, wherein the test subject observes and reacts to other characters interacting in the VSL scenario; a 1^{st} person perspective, wherein the test subject interacts in the VSL scenario; and a plurality of characters.

13. The method of claim 1, wherein the configuring the VSL scenario comprises configuring one or more subgroups of characters.

14. The method of claim 13, wherein the configuring the one or more subgroups of characters comprises at least one of an automatic generation of one or more character variables, and a custom generation of the one or more character variables.

15. The method of claim 1, wherein the configuring the VSL scenario comprises receiving a selection of one or more variables for a decider character, and receiving a selection of one or more variables for one or more characters seeking admittance within an environment.

16. The method of claim 5, wherein the configuring the VSL scenario comprises configuring the one or more interactions between the at least two characters.

17. The method of claim 1, wherein the configuring the VSL scenario comprises configuring at least one of a timing, a content, and a format of one or more scenario questions.

18. The method of claim 1, wherein the test subject input provides an objective measure of at least one of bias perception, individual attitudes, and other socially-observable phenomenon.

19. A system for conducting a study in a virtual social lab (VSL), comprising:
a scenario creation tool operable to receive one or more parameters for configuring a VSL scenario, and to create the VSL scenario;
a scenario running tool operable to run the VSL scenario for at least one test subject, and to receive test subject input based on the VSL scenario; and
a data storage tool operable to store the test subject input.

20. A computer program product for conducting a study in a virtual social lab (VSL), the computer program product comprising a computer usable non-transitory storage medium having readable program code embodied in the storage medium, the computer program product includes at least one component operable to:
configure a virtual social lab (VSL) scenario;
run the VSL scenario for at least one test subject;
receive test subject input based on the VSL scenario; and
store the test subject input.

21. A method for configuring a virtual social lab (VSL) scenario implemented in a computer infrastructure having computer executable code tangibly embodied on a computer readable medium, wherein the scenario includes an animated scene depicting an interaction between at least two characters in an environment, the method comprising:
configuring one or more scenario parameters using a processor of a computing device, the one or more parameters selected from: a number of interactions, a user input mode, an environment, a reject/accept ratio, and a percentage of occurrence of one or more character variables, wherein the one or more character variables comprise at least one of a gender, a race, a weight, a height, clothing, a degree of stereotypicality of skin tone, masculinity-femininity, an emotion on a character's face, an emotional expression indicated on (or by) a character's body, a gait, a voice, a disability, a usage of jewelry, a hairstyle, a personalization, an eye gaze, and a custom variable;
selecting a test subject perspective from one of: a 3^{rd} person perspective, wherein the test subject observes other characters interacting in the VSL scenario; a 1^{st} person perspective, wherein the test subject interacts in the VSL scenario; and a plurality of characters; and
configuring one or more interactions between the at least two characters.
